(19) United States
(12) Patent Application Publication
(10) Pub. No.: US 2025/0191233 A1
(43) Pub. Date: Jun. 12, 2025

(54) IMAGE PROCESSING APPARATUS, IMAGE PROCESSING METHOD, IMAGE CONVERSION APPARATUS, IMAGE CONVERSION METHOD, AI NETWORK GENERATION APPARATUS, AI NETWORK GENERATION METHOD, AND PROGRAM

(71) Applicant: Sony Semiconductor Solutions Corporation, Atsugi-shi, Kanagawa (JP)

(72) Inventor: Ryoji EKI, Kanagawa (JP)

(73) Assignee: Sony Semiconductor Solutions Corporation, Atsugi-shi, Kanagawa (JP)

(21) Appl. No.: 18/845,432

(22) PCT Filed: Mar. 28, 2023
(86) PCT No.: PCT/JP2023/012430

§ 371 Date: Sep. 10, 2024

(30) Foreign Application Priority Data
Mar. 28, 2022 (JP) 2022-051100

(51) Int. Cl. G06T 9/00; G06T 3/4046

(52) U.S. Cl. CPC G06T 9/002; G06T 3/4046

(57) ABSTRACT

The present disclosure relates to an image processing apparatus, an image processing method, an image conversion apparatus, an image conversion method, an AI network generation apparatus, an AI network generation method, and a program that allow implementation of image recognition processing based on RAW data.

Image recognition processing based on RAW data is implemented by generating a format conversion section that converts RGB data to RAW data by adversarial training and converting learning data including RGB data and a recognition result to learning data including RAW data and the recognition result to use the converted learning data for learning. The present disclosure can be applied to an image recognition apparatus.

### TECHNICAL FIELD

The present disclosure relates to an image processing apparatus, an image processing method, an image conversion apparatus, an image conversion method, an AI network generation apparatus, an AI network generation method, and a program, and particularly to an image processing apparatus, an image processing method, an image conversion apparatus, an image conversion method, an AI network generation apparatus, an AI network generation method, and a program that allow implementation of image recognition processing based on RAW data.

### BACKGROUND ART

There has been proposed a technique for implementing image recognition processing by using a recognizer including a neural network trained on the basis of RGB data (refer to PTL 1).

### Citation List

### Patent Literature

### [PTL 1]

PCT Patent Publication No. WO2021/079640

### SUMMARY

### Technical Problem

Incidentally, in the case of using a recognizer trained by RGB data, RGB data is required in implementation of image recognition processing.

The RGB data is data generated by demosaicing RAW data that is primitive image data arising from imaging by an imaging element, and virtually becomes data with a size three times the size of the RAW data. In addition, a partial texture is also lost due to the conversion to the RGB data.

Thus, in the case of using a recognizer that can implement image recognition processing by using the RAW data as it is, the volume of resources can be reduced. In addition, image recognition processing based on information free of also loss of a texture can be implemented. Therefore, improvement in the recognition accuracy can also be expected.

The recognizer that can implement image recognition processing by using the RAW data as it is needs to be trained by generating learning data by associating the RAW data with a recognition result that serves as training data.

However, learning data used for learning in general is learning data in which the RGB data and a recognition result are integrated. Learning data in which the RAW data and a recognition result have been integrated is not so abundantly distributed.

Thus, for training the recognizer that can implement image recognition processing by using the RAW data as it is, the learning data in which the RGB data and a recognition result have been integrated, which has a large amount of distribution in general, needs to be converted to the learning data in which the RAW data and the recognition result are integrated.

The present disclosure has been made in view of such a situation, and particularly allows conversion of RGB data to RAW data and implements image recognition processing based on the RAW data by generating learning data including the RAW data and a recognition result.

### Solution to Problem

An image processing apparatus and a program of a first aspect of the present disclosure are an image processing apparatus and a program including a format conversion section that converts RGB data to RAW data.

An image processing method of the first aspect of the present disclosure is an image processing method including a step of converting RGB data to RAW data.

In the first aspect of the present disclosure, the RGB data is converted to the RAW data.

An image processing apparatus and a program of a second aspect of the present disclosure are an image processing apparatus and a program including a RAW data recognition section that executes image recognition processing on the basis of an image of RAW data.

An image processing method of the second aspect of the present disclosure is an image processing method including a step of executing image recognition processing on the basis of an image of RAW data.

In the second aspect of the present disclosure, the image recognition processing is executed on the basis of the image of the RAW data.

An image processing apparatus of a third aspect of the present disclosure is an image processing apparatus including an image recognition section to which image data corresponding to an image of a first arrangement according to an arrangement of a pixel array including an imaging element is input. The image recognition section executes image recognition processing for the image data and outputs a recognition processing result. The image recognition section is trained by using the image data corresponding to the image of the first arrangement generated by converting an image of a second arrangement different from the first arrangement.

An image processing method of the third aspect of the present disclosure is an image processing method of an image processing apparatus including an image recognition section to which image data corresponding to an image of a first arrangement according to an arrangement of a pixel array including an imaging element is input. The image recognition section executes image recognition processing for the image data and outputs a recognition processing result. The image processing method includes a step of, by the image recognition section, executing the image recognition processing for the image data and outputting the recognition processing result after execution of learning of the image recognition processing using the image data corresponding to the image of the first arrangement generated by conversion of an image of a second arrangement different from the first arrangement.

In the third aspect of the present disclosure, the image data corresponding to the image of the first arrangement according to the arrangement of the pixel array including the imaging element is input. The image recognition processing is executed for the image data and the recognition processing result is output. The learning is executed by using the image data corresponding to the image of the first arrangement generated by converting the image of the second arrangement different from the first arrangement.

An image conversion apparatus of a fourth aspect of the present disclosure is an image conversion apparatus including an image conversion section that converts an RGB image having an R image, a G image, and a B image to an image including another arrangement different from an arrangement of the RGB image output according to an arrangement of a pixel array including an imaging element. The image including the other arrangement is used for learning of an image recognition section used for image inference processing based on the image including the other arrangement.

An image conversion method of the fourth aspect of the present disclosure is an image conversion method including a step of converting an RGB image having an R image, a G image, and a B image to an image including another arrangement different from an arrangement of the RGB image output according to an arrangement of a pixel array including an imaging element. The image including the other arrangement is used for learning of an image recognition section used for image inference processing based on the image including the other arrangement.

In the fourth aspect of the present disclosure, the RGB image having the R image, the G image, and the B image is converted to the image including another arrangement different from the arrangement of the RGB image output according to the arrangement of the pixel array including the imaging element. The image including the other arrangement is used for the learning of the image recognition section used for the image inference processing based on the image including the other arrangement.

An AI network generation apparatus of a fifth aspect of the present disclosure is an AI network generation apparatus including an image conversion section that converts an input image of a first arrangement to an image of a second arrangement different from the first arrangement and outputs the image of the second arrangement and an AI network training section that generates a trained AI network by training an AI network by using the image of the second arrangement output from the image conversion section.

An AI network generation method of the fifth aspect of the present disclosure is an AI network generation method including steps of converting an input image of a first arrangement to an image of a second arrangement different from the first arrangement and outputting the image of the second arrangement and generating a trained AI network by training an AI network by using the output image of the second arrangement.

In the fifth aspect of the present disclosure, the input image of the first arrangement is converted to the image of the second arrangement different from the first arrangement and the image of the second arrangement is output. The trained AI network is generated by training of the AI network by use of the output image of the second arrangement.

### BRIEF DESCRIPTION OF DRAWINGS

FIG. 1 is a diagram explaining a configuration example of an image recognition apparatus based on RGB data.

FIG. 2 is a diagram explaining a configuration example of an image recognition apparatus based on RAW data.

FIG. 3 is a diagram explaining learning of an RGB recognition section in FIG. 1.

FIG. 4 is a diagram explaining learning of a Bayer recognition section in FIG. 2.

FIG. 5 is a diagram explaining the outline of the present disclosure.

FIG. 6 is a diagram explaining a configuration example of a preferred embodiment of a learning apparatus of the present disclosure.

FIG. 7 is a diagram explaining the premise of format conversion.

FIG. 8 is a diagram explaining a configuration example of a learning apparatus.

FIG. 9 is a diagram explaining a configuration example of an image recognition apparatus.

FIG. 10 is a flowchart explaining training processing for a determination section and a format conversion section in the learning apparatus of FIG. 6.

FIG. 11 is a flowchart explaining Bayer recognition training processing.

FIG. 12 is a flowchart explaining image recognition processing by the image recognition apparatus of FIG. 9.

FIG. 13 is a diagram explaining a modification example of the image recognition apparatus.

FIG. 14 is a flowchart explaining image recognition processing by the image recognition apparatus of FIG. 13.

FIG. 15 is a diagram explaining a modification example of the learning apparatus.

FIG. 16 is a flowchart explaining training processing by the learning apparatus of FIG. 15.

FIG. 17 is a diagram explaining an application example of the image recognition apparatus.

FIG. 18 is a diagram explaining an application example of the format conversion section.

FIG. 19 is a diagram explaining a variation of a format in which 2×2 pixels form a pixel block.

FIG. 20 is a diagram explaining a variation of the format in which 2×2 pixels form the pixel block.

FIG. 21 is a diagram explaining a variation of a format in which 4×2 pixels form a pixel block.

FIG. 22 is a diagram explaining a variation of a format in which 3×3 pixels form a pixel block.

FIG. 23 is a diagram explaining a variation of the format in which 3×3 pixels form the pixel block.

FIG. 24 is a diagram explaining a variation of the format in which 3×3 pixels form the pixel block.

FIG. 25 is a diagram explaining a variation of the format in which 3×3 pixels form the pixel block.

FIG. 26 is a diagram explaining a variation of a format in which 4×4 pixels form a pixel block.

FIG. 27 is a diagram explaining a variation of the format in which 4×4 pixels form the pixel block.

FIG. 28 is a diagram explaining variations of the format in which 4×4 pixels form the pixel block.

FIG. 29 is a diagram explaining a variation of a format including pixels of a color in a wavelength band other than those of RGB pixels.

FIG. 30 is a diagram explaining a variation of a format including pixels of colors in wavelength bands other than those of the RGB pixels.

FIG. 31 is a diagram explaining a variation of the format including pixels of a color in a wavelength band other than those of the RGB pixels.

FIG. 32 is a diagram explaining a variation of the format including pixels of colors in wavelength bands other than those of the RGB pixels.

FIG. 33 is a diagram explaining a variation of the format including pixels of colors in wavelength bands other than those of the RGB pixels.

FIG. 34 is a diagram explaining a variation of the format including pixels of colors in wavelength bands other than those of the RGB pixels.

FIG. 35 is a diagram explaining a variation of the format including pixels of colors in wavelength bands other than those of the RGB pixels.

FIG. 36 is a diagram explaining a variation of the format including pixels of colors in wavelength bands other than those of the RGB pixels.

FIG. 37 illustrates a configuration example of a general-purpose computer.

### DESCRIPTION OF EMBODIMENT

A preferred embodiment of the present disclosure will be described in detail below with reference to the accompanying drawings. Note that, in the present specification and the drawings, overlapping description is omitted by giving the same numeral regarding a constituent element having substantially the same functional configuration.

Modes for carrying out the present technique will be described below. The description will be made in the following order.
1. Outline of Image Recognition Apparatus
2. Preferred Embodiment
3. Modification Example of Image Recognition Apparatus
4. Modification Example of Learning Apparatus
5. Application Example of Image Recognition Apparatus
6. Application Example of Format Conversion Section
7. Variations of RAW Data to Which Conversion Is Executed by Format Conversion Section
8. Example of Execution by Software

### 1. Outline of Image Recognition Apparatus

### <Configuration Example of Image Recognition Apparatus That Recognizes Thing on the Basis of RGB Data>

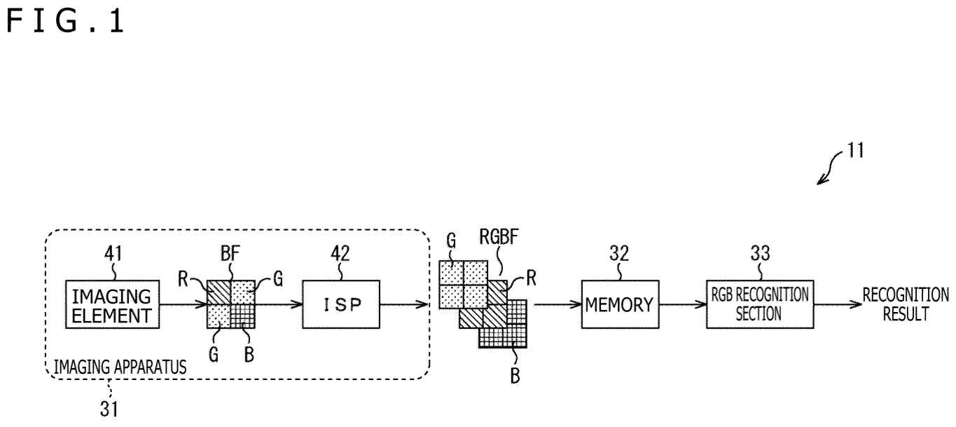

The outline of an image recognition apparatus that recognizes a thing on the basis of RGB data will be described with reference to FIG. 1.

An image recognition apparatus 11 of FIG. 1 includes an imaging apparatus 31, a memory 32, and an RGB recognition section 33.

The imaging apparatus 31 captures an image that becomes a recognition target, and stores RGB data (RGB image) RGBF that is the imaging result in the memory 32.

The RGB recognition section 33 is a recognizer such as an AI (Artificial Intelligence) including a neural network for which machine learning based on the RGB data RGBF and a corresponding recognition result has been executed, and recognizes a thing on the basis of the RGB data RGBF stored in the memory 32.

The imaging apparatus 31 includes an imaging element 41 and an ISP 42. The imaging element 41 includes a pixel array in which pixels including CMOS (Complementary Metal Oxide Semiconductor) image sensors or CCD (Charge Coupled Device) image sensors are disposed in an array manner. The imaging element 41 generates RAW data BF including a pixel signal according to the amount of incident light in units of each pixel, and outputs the RAW data BF to the ISP 42.

Note that, in FIG. 1, an example of the RAW data BF in the case in which a color filter of the Bayer arrangement is formed on the incident surface of the imaging element 41 is illustrated and, as a disposing example of 2 pixels×2 pixels, a disposing example in which pixels are arranged in order of R (red), G (green), G (Green), and B (blue) from the upper side to the lower side and from the left to the right is illustrated. Hereinafter, the indication of the disposing of 2 pixels×2 pixels in the RAW data BF is expressed by only the pattern of the square expressing each pixel, and representation of RGGB or the like with lead lines is omitted.

The ISP (Image Signal Processor) 42 generates three images, an R image, a G image, and a B image, by executing demosaicing processing regarding each of RGB on the basis of the RAW data BF, and combines them to output them to the memory 32 as the RGB data RGBF and store it.

Note that, in FIG. 1, the RGB data RGBF is expressed as data in which an image of 2 pixels×2 pixels is collected regarding each of the G image, the R image, and the B image from the left in the diagram. Hereinafter, the indication of the disposing of 2 pixels×2 pixels in the RGB data RGBF is expressed by only the pattern of the square expressing each pixel, and representation of RGB with lead lines is omitted. Furthermore, the pattern of each of RGB in the squares corresponds to the RAW data BF.

Here, due to the conversion to the data arising from demosaicing regarding each of R, G, and B on the basis of the RAW data BF, the RGB data RGBF has a data amount three times that of the RAW data BF. Furthermore, simultaneously loss of texture information occurs.

It is desirable that recognition processing based on the RAW data BF instead of the RGB data RGBF be executed in order to allow the limited capacity of the memory 32 to be saved as much as possible in view of mounting of the image recognition apparatus 11 in portable communication equipment typified by the smartphone and in order to suppress the loss of texture information to improve the recognition accuracy.

<Configuration Example of Image Recognition Apparatus that Recognizes Thing on the Basis of RAW Data>

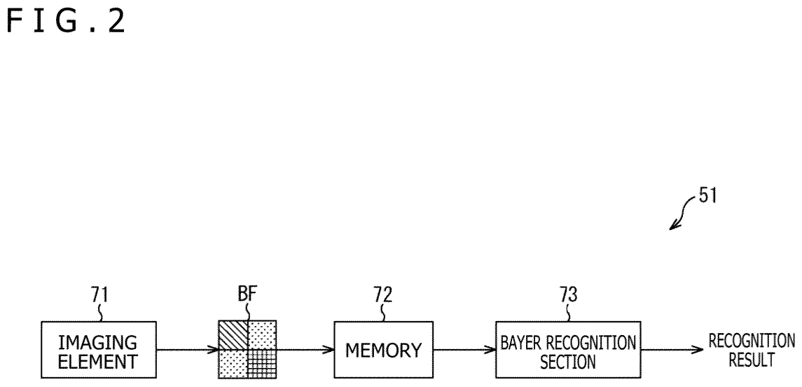

That is, it can be said that an image recognition apparatus that recognizes a thing on the basis of RAW data like one illustrated in FIG. 2 is a configuration desirable in terms of saving the capacity of the memory and improving the recognition accuracy. An image recognition apparatus 51 of FIG. 2 includes an imaging element 71, a memory 72, and a Bayer recognition section 73.

Note that the imaging element 71, the memory 72, and the Bayer recognition section 73 are configurations corresponding to the imaging element 41, the memory 32, and the RGB recognition section 33 in FIG. 1 and the imaging element 71 and the imaging element 41 are the same.

Differences of the image recognition apparatus 51 of FIG. 2 from the image recognition apparatus 11 of FIG. 1 are as follows: the ISP 42 is omitted; the RAW data BF based on an image captured by the imaging element 71 is stored in the memory 72 as it is; and the Bayer recognition section 73 is disposed instead of the RGB recognition section 33.

The Bayer recognition section 73 is a recognizer such as an AI (Artificial Intelligence) including a neural network for which machine learning based on the RAW data BF and a corresponding recognition result has been executed, and recognizes a thing on the basis of the RAW data BF stored in the memory 72.

Due to the configuration like the image recognition apparatus 51 of FIG. 2, the image used for the recognition processing becomes the RAW data BF. This can reduce the data amount to ⅓ of that of the RGB data RGBF and thus reduce the use amount of the memory 72 to ⅓.

Furthermore, loss of a texture occurs due to conversion of the RAW data BF to the RGB data RGBF. However, the use of the RAW data in the recognition processing can implement the recognition processing by an image free of loss of a texture. Therefore, improvement in the recognition accuracy can be expected.

### <Learning of RGB Recognition Section>

The Bayer recognition section 73 needs to be generated by learning for implementing the image recognition apparatus 51 of FIG. 2. For consideration of the generation of the Bayer recognition section 73 by learning, first, learning of the RGB recognition section 33 will be described.

As described above, the RGB recognition section 33 is a recognizer including a neural network for which machine learning based on the RGB data RGBF and a recognition result that serves as corresponding training data has been executed.

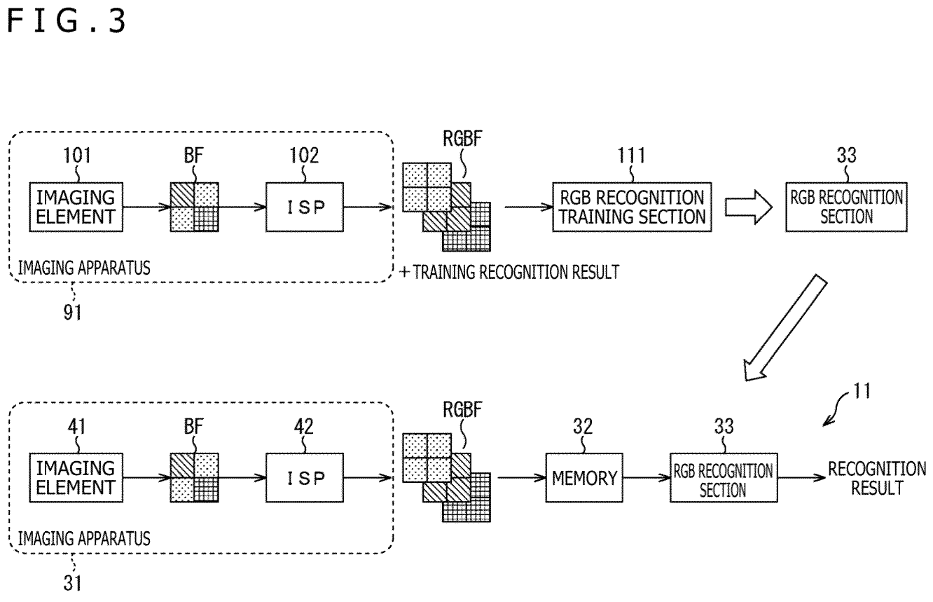

Thus, as illustrated in FIG. 3, an RGB recognition training section 111 generates the RGB recognition section 33 by executing machine learning using the RGB data RGBF arising from imaging by an imaging apparatus 91 corresponding to the imaging apparatus 31 and a recognition result that serves as corresponding training data (training recognition result).

Note that the imaging apparatus 91 includes an imaging element 101 and an ISP 102 and both are the same configuration as the imaging element 41 and the ISP 42 in the imaging apparatus 31.

That is, the RGB recognition section 33 is generated by the machine learning using the RGB data RGBF generated by imaging by a general imaging apparatus such as the imaging apparatus 31 or 91 and the recognition result that serves as the corresponding training data (training recognition result), and is used for the image recognition apparatus 11.

### <Learning of Bayer Recognition Section>

Next, learning of the Bayer recognition section 73 of the image recognition apparatus 51 of FIG. 2 will be described.

As described above, the Bayer recognition section 73 is a recognizer including a neural network for which machine learning based on the RAW data BF and a recognition result that serves as corresponding training data (training recognition result) has been executed.

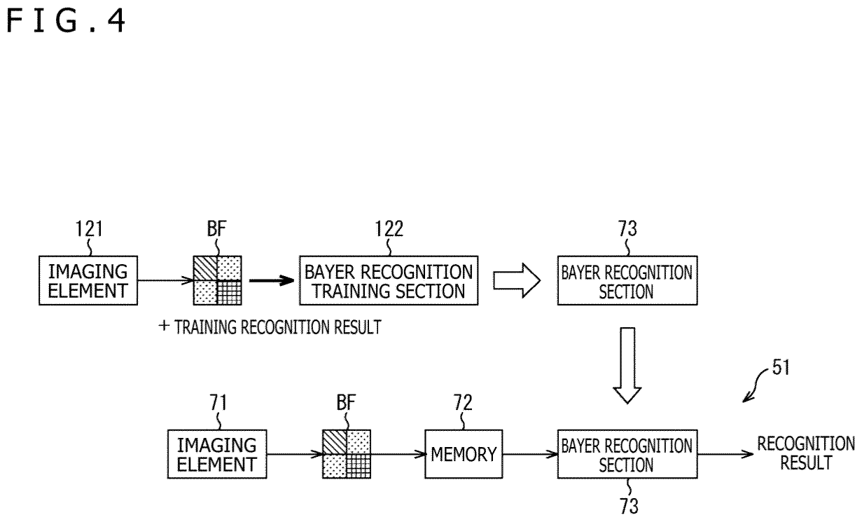

Thus, as illustrated in FIG. 4, a Bayer recognition training section 122 generates the Bayer recognition section 73 by executing machine learning using the RAW data BF arising from imaging by an imaging element 121 corresponding to the imaging element 71 and a recognition result that serves as corresponding training data (training recognition result).

Note that the imaging element 121 is the same configuration as the imaging element 71.

That is, the Bayer recognition section 73 is generated by the machine learning using the RAW data BF generated by imaging by the imaging element 121 and the recognition result that serves as the corresponding training data (training recognition result), and is used for the image recognition apparatus 51.

### <Conversion of RGB Data to RAW Data>

Incidentally, as described above, in the general imaging apparatuses 31 and 91, when the RAW data BF is obtained by imaging in the imaging element 41, the RAW data BF is converted to the RGB data RGBF by demosaicing regarding each of RGB, and the RGB data RGBF is output as the imaging result.

Thus, it is general that data for learning including the RGB data RGBF and the recognition result that serves as the corresponding training data (training recognition result) as a set is used for learning of the recognizer. Due to this, the image recognition apparatus 11 using the RGB recognition section 33 is thought of as a general configuration.

Among imaging apparatuses, there are ones that can also output a captured image as RAW data. However, as data for learning, data for learning including RAW data and a recognition result that serves as training data as a set is not so abundantly distributed in general.

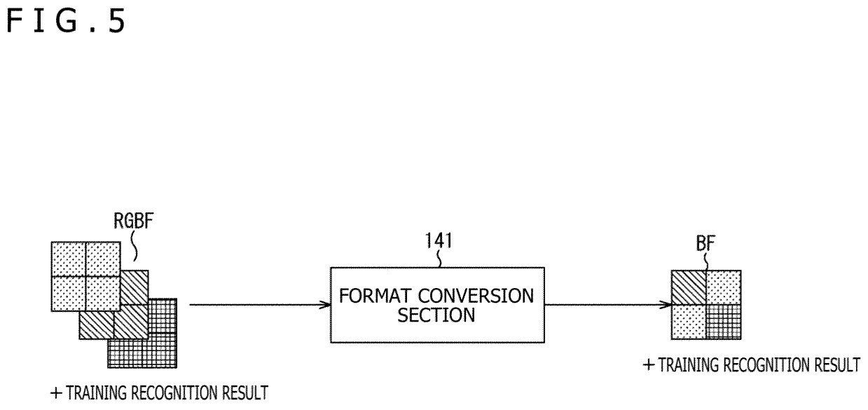

Thus, in the present disclosure, by proposing a signal processing apparatus like a format conversion section 141 illustrated in FIG. 5, format conversion is executed from data for learning including a set of the RGB data RGBF and a recognition result that serves as training data (training recognition result), which is distributed as data for learning in general, to data for learning including a set of the RAW data BF and the recognition result that serves as training data (training recognition result).

Note that the recognition result that serves as training data includes information corresponding to the position in an image, and therefore can be used as it is as information regarding the position on the corresponding image as long as the RGB data RGBF can be converted to the RAW data BF.

That is, substantially, as long as the RGB data RGBF can be converted to the RAW data BF, format conversion can be executed from data for learning including a set of the RGB data RGBF and a recognition result that serves as training data (training recognition result), which is abundantly distributed in general, to data for learning including a set of the RAW data BF and the recognition result that serves as training data (training recognition result).

### 2. Preferred Embodiment

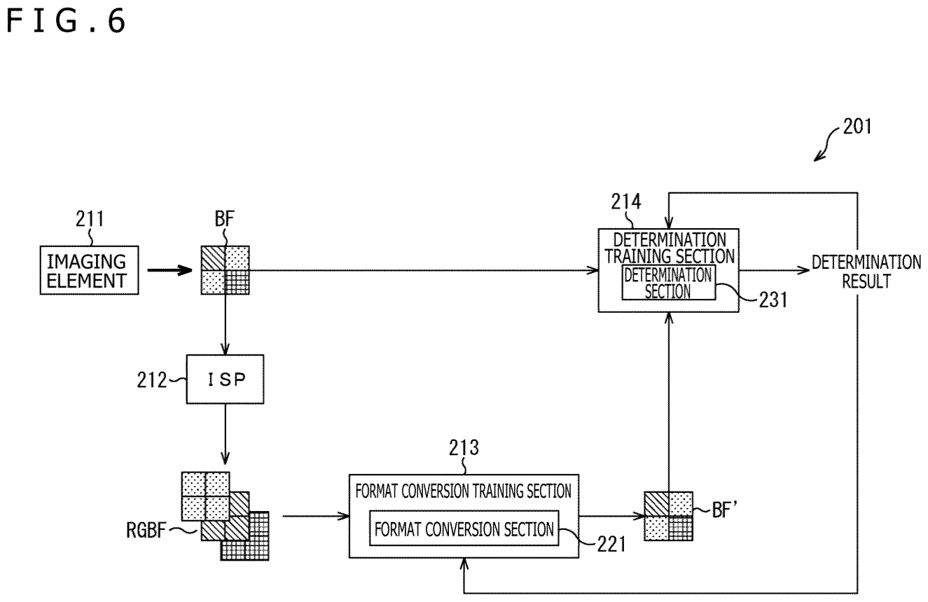

Next, with reference to FIG. 6, a learning apparatus for generating the above-described format conversion section 141 will be described.

A learning apparatus 201 of FIG. 6 includes a neural network called a GAN (Generative Adversarial Network), and generates, by learning, the format conversion section 141 and a determination section that determines the authenticity of the conversion result by the format conversion section 141.

The GAN is made into a network structure including two networks, a generation network (generator) and a discrimination network (discriminator).

In general, in the generation network (generator), by learning characteristics from data, a generation section that generates non-existent data or a converter that converts data along characteristics of existent data is generated by the learning.

The format conversion section 141 of the present disclosure is generated by learning in the generation network in the GAN forming the learning apparatus 201 of FIG. 6.

Furthermore, in general, in the discrimination network (discriminator), a determination section that determines the authenticity of a product or a conversion result by the generation section or the converter generated by learning in the generation network (generator) is generated by learning.

That is, in general, in the GAN, in the generation network, the generation section or the converter is trained to be capable of deceiving the determination section generated by the discrimination network regarding the authenticity determination. In the discrimination network, the determination section is trained to be capable of more accurately discriminating the authenticity.

As above, the two networks, the discrimination network (discriminator) and the generation network (generator), in the GAN generate the generation section or the converter and the determination section having contradictory purposes by adversarially training them.

More specifically, the learning apparatus 201 of FIG. 6 includes an imaging element 211, an ISP 212, a format conversion training section 213 that trains a format conversion section 221, and a determination training section 214 that trains a determination section 231.

The imaging element 211 includes a color filter of the Bayer arrangement, and captures an image in data for learning and outputs the image to the ISP 212 and the determination training section 214 as the RAW data BF of the Bayer arrangement.

The ISP 212 is a configuration corresponding to the ISPs 42 and 102. The ISP 212 generates three images, an R image, a G image, and a B image, by executing demosaicing processing regarding each of RGB on the basis of the RAW data BF, and combines them to output them to the format conversion training section 213 as the RGB data RGBF.

The format conversion training section 213 is the generation network (generator) in the GAN, and trains the format conversion section 221 that converts the RGB data RGBF to RAW data BF′ and corresponds to the format conversion section 141. Note that, although the RAW data BF′ is the conversion result of restoration from the RGB data RGBF to the RAW data BF, complete restoration is often impossible in the conversion and therefore “′” is given in order to express that the restored RAW data is not completely the same.

That is, the format conversion training section 213 trains the format conversion section 221 to allow conversion to the RAW data BF′ with higher accuracy (so as to obtain RAW data BF′=RAW data BF) on the basis of the RAW data BF′, which is the conversion result by the format conversion section 221, and the determination result by the determination section 231 in the determination training section 214 based on the corresponding RAW data BF.

The determination training section 214 is the discrimination network (discriminator) in the GAN, and causes the determination section 231 to compare the RAW data BF′, which is the format conversion result by the format conversion section 221, with the original RAW data BF supplied from the imaging element 211 and determine the authenticity, and outputs the determination result to the format conversion training section 213.

Moreover, the determination training section 214 trains the determination section 231 on the basis of the RAW data BF′, which is the format conversion result by the format conversion section 221, the original RAW data BF supplied from the imaging element 211, and the determination result relating to the authenticity between both.

That is, the determination section 231 compares the RAW data BF with the RAW data BF′ and determines the authenticity, and the determination training section 214 trains the determination section 231 to allow discrimination between the RAW data BF and the RAW data BF′ with high accuracy on the basis of the RAW data BF′, the RAW data BF, and the determination result by the determination section 231.

In such a manner, the format conversion section 221 and the determination section 231 are generated by learning by the learning apparatus 201.

This can convert a widely-distributed dataset for learning including the RGB data RGBF and a recognition result that serves as training data (training recognition result) to a dataset for learning including RAW data and the recognition result that serves as training data.

Note that it is assumed that the image size of the input image in the format conversion section 221 is larger than the image size of the output image.

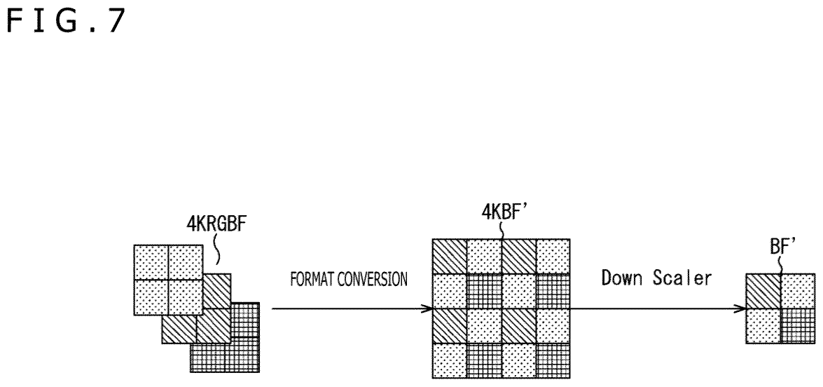

Therefore, in the case in which RAW data of an image with the 4K size is expressed as RAW data 4KBF and RGB data with the 4K size is expressed as RGB data 4KRGBF, for example, as illustrated in FIG. 7, when the image size of the input image is the 4K size, the format conversion section 221 converts the RGB data 4KRGBF with the 4K size generated by demosaicing of the RAW data 4KBF to RAW data 4KBF′ with the 4K size and thereafter further downscales the RAW data 4KBF′ and outputs the downscaled data as the RAW data BF′.

The purpose of this is to reduce the influence attributed to loss of texture information by the downscaling because the texture information is lost when the RAW data 4KBF with the 4K size is demosaiced to be converted to the RGB data 4KRGBF.

Note that, in description made hereinafter, the sizes of the input image and the output image are both unified with an expression in conformity with the size of the output image and the description will be advanced without particularly mentioning the downscaling. However, actually, the above-described downscaling is executed.

### <Learning Apparatus for Training Bayer Recognition Section>

Using the format conversion section 221 can train a Bayer recognition section that executes image recognition processing on the basis of an image of RAW data from data for learning including the RGB data RGBF and a recognition result that serves as training data.

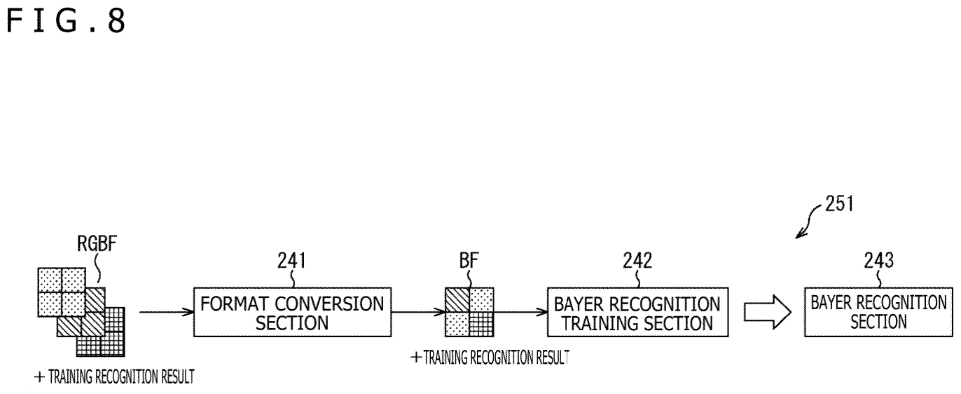

FIG. 8 illustrates a configuration example of a learning apparatus that trains the Bayer recognition section that executes image recognition processing on the basis of an image of RAW data from data for learning including the RGB data RGBF and a recognition result that serves as training data.

A learning apparatus 251 of FIG. 8 includes a format conversion section 241 and a Bayer recognition training section 242.

The format conversion section 241 is the same configuration as the format conversion section 221 in FIG. 6, and converts widely-distributed data for learning including the RGB data RGBF and a recognition result that serves as training data to data for learning including RAW data and the recognition result that serves as training data to output the data for learning to the Bayer recognition training section 242.

By using the data for learning including RAW data and a recognition result that serves as training data, the Bayer recognition training section 242 generates, by learning, a Bayer recognition section 243 such as an AI (Artificial Intelligence) including a neural network that executes image recognition processing based on an image of RAW data.

<Image Recognition Apparatus that Executes Image Recognition Processing Based on Image of RAW Data>

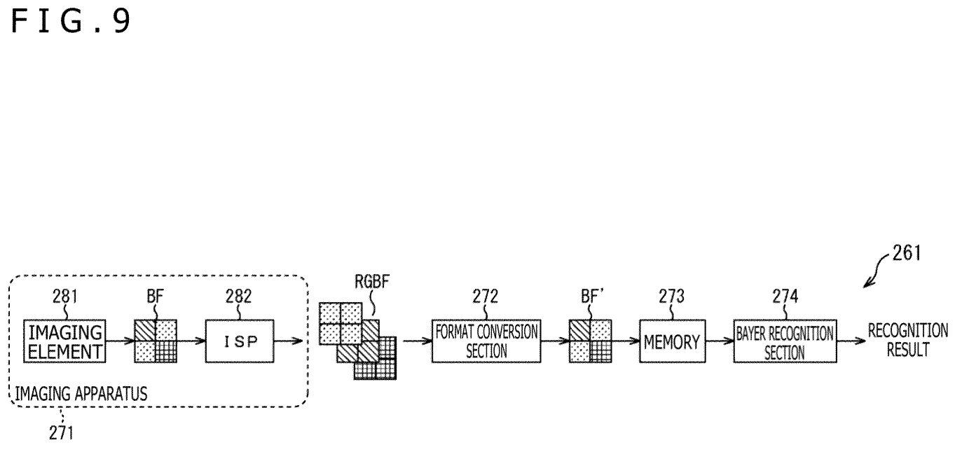

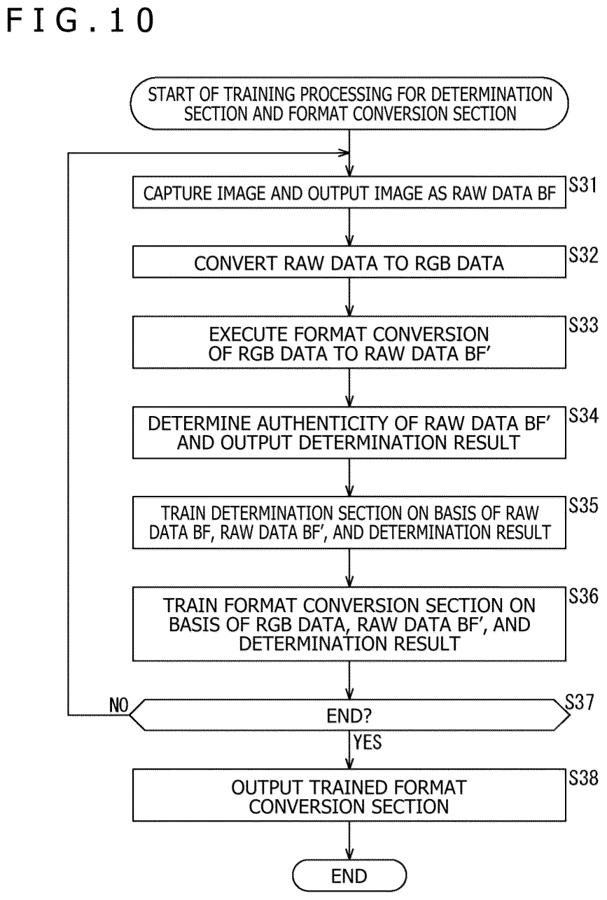

Moreover, due to the generation of the format conversion section 221 and the Bayer recognition section 243, an image recognition apparatus illustrated in FIG. 9 is implemented.

An image recognition apparatus 261 of FIG. 9 includes an imaging apparatus 271, a format conversion section 272, a memory 273, and a Bayer recognition section 274.

The imaging apparatus 271 is a general imaging apparatus and includes an imaging element 281 and an ISP 282. The imaging element 281 is a configuration corresponding to the imaging element 41, and captures an image and outputs the image as the RAW data BF. The ISP 282 is a configuration corresponding to the ISP 42, and generates the RGB data RGBF from the RAW data BF by demosaicing and outputs the RGB data RGBF as the imaging result.

The format conversion section 272 is the same configuration as the format conversion section 221 in FIG. 6, and executes format conversion of the RGB data RGBF output as the imaging result by the general imaging apparatus 271 to the RAW data BF′ and stores it in the memory 273.

The Bayer recognition section 274 is, for example, the Bayer recognition section 243 generated by learning processing by the learning apparatus 251 of FIG. 8, and executes image recognition processing on the basis of an image of the RAW data BF′ stored in the memory 273 to output the recognition result.

Note that the image recognition processing implemented in the present disclosure includes, for example, detection processing and recognition processing for a specific thing or object such as a person or vehicle, semantic segmentation, classification, detection processing for the skeleton of a person, character recognition processing (OCR: Optical Character Recognition), and the like that are based on an image.

As above, data including the RAW data BF′ with a volume that is approximately ⅓ of that of the RGB data RGBF is stored in the memory 273. Therefore, the capacity of the memory 273 can be saved.

Furthermore, because the capacity of the memory 273 can be saved, in view of mounting of the image recognition apparatus 261 in portable communication equipment or the like typified by the smartphone, the size itself of the memory 273 can be reduced, and size reduction of the apparatus configuration can be implemented.

### <Training Processing for Determination Section and Format Conversion Section in Learning Apparatus of FIG. 6>

Next, with reference to a flowchart of FIG. 9, training processing for the determination section 231 and the format conversion section 221 by the learning apparatus 201 of FIG. 6 will be described.

In step S31, the imaging element 211 captures an image and outputs the image to the ISP 212 and the determination training section 214 as the RAW data BF of the Bayer arrangement. Note that, in this processing, as long as an image of the new RAW data BF can be acquired, the imaging result by the imaging element 211 does not need to be used and an image of the RAW data BF that can be acquired and has been imaged by another imaging element or the like may be used.

In step S32, the ISP 212 converts the RAW data BF to the RGB data RGBF by demosaicing and outputs the RGB data RGBF to the format conversion training section 213.

In step S33, the format conversion training section 213 causes the format conversion section 221 to execute format conversion of the RGB data RGBF to the RAW data BF′, and outputs the RAW data BF′ to the determination training section 214.

In step S34, the determination training section 214 controls the determination section 231 to compare the RAW data BF from the imaging element 211 with the RAW data BF′ from the format conversion training section 213 and determine the authenticity of the RAW data BF′, and outputs the determination result.

In step S35, the determination training section 214 trains the determination section 231 on the basis of the RAW data BF, the RAW data BF′, and the determination result.

In step S36, the format conversion training section 213 trains the format conversion section 221 on the basis of the RGB data RGBF, the RAW data BF′, and the determination result.

In step S37, whether or not an instruction to end the training has been made is determined. In the case in which an instruction to end the training has not been made, the processing returns to step S31, and the subsequent processing is repeated.

That is, until an instruction to end the training is made, a new image is captured by the imaging element 211, and adversarial training of the format conversion section 221 and the determination section 231 is repeated.

Then, in the case in which an instruction to end the training has been made in step S37, the processing proceeds to step S38.

In step S38, the format conversion training section 213 outputs the trained format conversion section 221.

Through the above processing, the format conversion section 221 and the determination section 231 are trained by the adversarial training of the format conversion section 221 and the determination section 231 with the RAW data BF, and the format conversion section 221 is generated and output as the training result.

This allows the format conversion section 221 to convert, to the RAW data BF, the RGB data RGBF in a dataset for learning including the RGB data RGBF and a recognition result that serves as training data as a set, which has a large amount of distribution.

As a result, it becomes possible to convert the dataset for learning including the RGB data RGBF and a recognition result that serves as training data as a set, which has a large amount of distribution, to a dataset for learning including the RAW data BF and the recognition result that serves as training data as a set.

Furthermore, it becomes possible to easily generate a large amount of the dataset for learning including the RAW data BF and a recognition result that serves as training data as a set. Therefore, the Bayer recognition section that recognizes a thing can be easily trained and generated on the basis of the RAW data BF.

### <Bayer Recognition Section Training Processing>

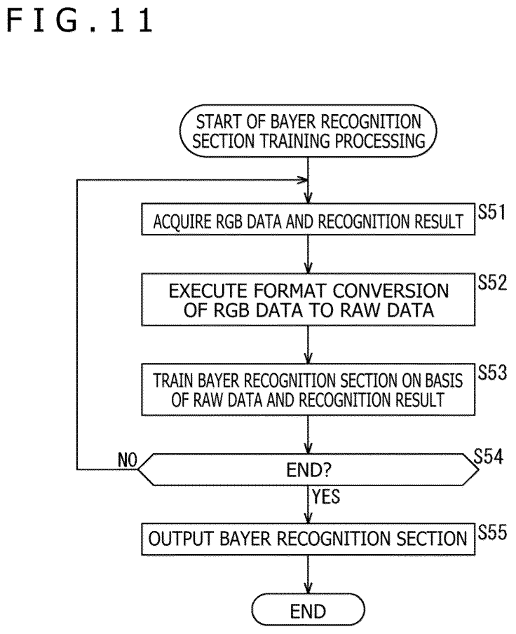

Next, with reference to a flowchart of FIG. 11, description will be made about Bayer recognition section training processing that is training processing for the Bayer recognition section 243 by the learning apparatus 251 of FIG. 8.

In step S51, the format conversion section 241 acquires a dataset for learning including the RGB data RGBF that has not been processed and a recognition result that serves as training data as a set.

In step S52, the format conversion section 241 executes format conversion of the RGB data RGBF to the RAW data BF in the data for learning including the RGB data RGBF and the recognition result that serves as training data as a set, and associates the RAW data BF with the recognition result that serves as training data to output them as data for learning.

In step S53, the Bayer recognition training section 242 trains the Bayer recognition section 243 on the basis of the data for learning including the RAW data BF and the recognition result that serves as training data.

In step S54, whether or not an instruction to end the training has been made is determined. In the case in which an instruction to end the training has not been made, the processing returns to step S51, and the subsequent processing is repeated.

That is, until an instruction to end the training is made, the processing of steps S51 to S54 is repeated, and the training of the Bayer recognition section 243 is repeated.

Then, when an instruction to end the training is made in step S54, the processing proceeds to step S55.

In step S55, the Bayer recognition training section 242 outputs the trained Bayer recognition section 243.

By the above processing, the Bayer recognition section 243 that recognizes a thing can be trained on the basis of the dataset for learning including the RAW data BF and the recognition result that serves as training data as a set.

### <Image Recognition Processing by Image Recognition Apparatus of FIG. 9>

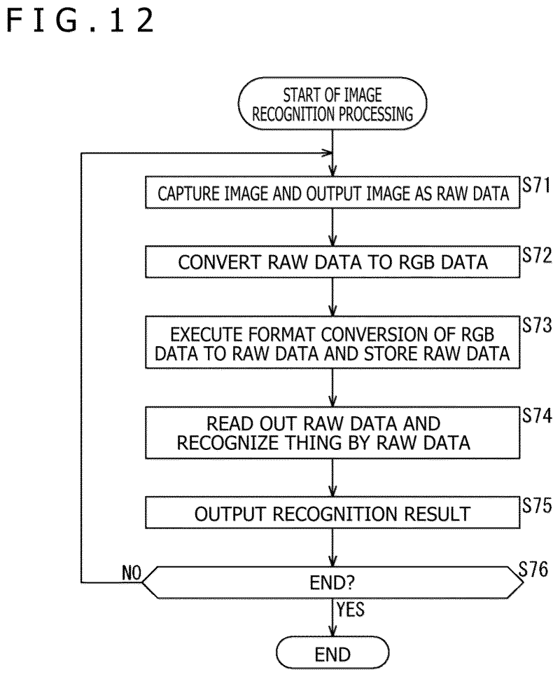

Next, with reference to a flowchart of FIG. 12, image recognition processing by the image recognition apparatus 261 of FIG. 9 will be described.

In step S71, the imaging element 281 of the imaging apparatus 271 captures an image and outputs the image to the ISP 282 as the RAW data BF.

In step S72, the ISP 282 converts the RAW data BF to the RGB data RGBF by demosaicing regarding each of RGB and outputs the RGB data RGBF to the format conversion section 272 as the imaging result.

In step S73, the format conversion section 272 executes format conversion of the RGB data RGBF to the RAW data BF and stores the RGB data RGBF in the memory 273.

In step S74, the Bayer recognition section 274 reads out the stored RAW data BF from the memory 273, and executes image recognition processing to recognize a thing on the basis of an image of the RAW data BF.

In step S75, the Bayer recognition section 274 outputs the recognition result based on the image of the RAW data BF.

In step S76, whether or not an instruction to end the image recognition processing has been made is determined. In the case in which an instruction to end the processing has not been made, the processing returns to step S71, and the subsequent processing is repeated.

That is, until an instruction to end the processing is made, an image of the RGB data RGBF obtained by imaging by the imaging apparatus 271 is subjected to format conversion to RAW data, and the image recognition processing based on an image of the RAW data arising from the format conversion is repeated.

Then, when an instruction to end the processing is made in step S76, the image recognition processing is ended.

By the above processing, the image recognition processing by the RAW data BF is implemented, and thus the required capacity of the memory 273 can be reduced.

Furthermore, in the case of assuming mounting of the format conversion section 272, the memory 273, and the Bayer recognition section 274 on one chip, that is, what is called an SoC (System on Chip), in the image recognition apparatus 261 of FIG. 9, the size of the memory 273 can be reduced because the capacity of the memory 273 can be saved. As a result, the size of the chip itself can be reduced.

### 3. Modification Example of Image Recognition Apparatus

In the above, the imaging apparatus 271 is disposed in the image recognition apparatus 261, and the imaging result is output as an image of the RGB data RGBF. Therefore, the image recognition processing needs to be executed in the Bayer recognition section 274 after the RGB data RGBF as the imaging result is converted by the format conversion section 221.

However, the image recognition processing may be executed in the Bayer recognition section 274 in such a manner that the RAW data BF output from the imaging element 281 is output as the imaging result as it is.

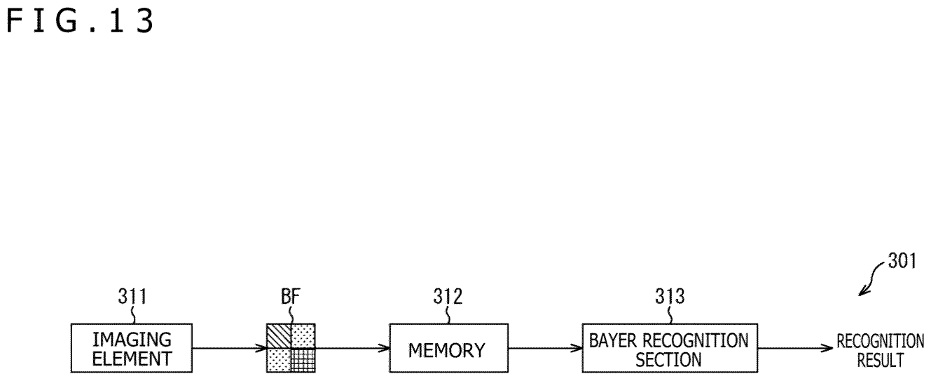

FIG. 13 illustrates a configuration example of an image recognition apparatus configured in such a manner that the RAW data BF is output as the imaging result and image recognition processing based on the RAW data BF is executed.

Differences of an image recognition apparatus 301 of FIG. 13 from the image recognition apparatus 261 of FIG. 9 are as follows. Only an imaging element 311 is disposed instead of the imaging apparatus 271. In association with this, the format conversion section 221 is omitted. Due to this, the RAW data BF is output as it is to a memory 312 as the imaging result.

That is, the image recognition apparatus 301 of FIG. 13 includes the imaging element 311, the memory 312, and a Bayer recognition section 313.

The imaging element 311, the memory 312, and the Bayer recognition section 313 are configurations corresponding to the imaging element 281, the memory 273, and the Bayer recognition section 243, respectively, in FIG. 8.

Due to such a configuration, when an image is captured by the imaging element 311, the RAW data BF is output as the imaging result and is stored in the memory 312.

The Bayer recognition section 313 reads out the RAW data BF stored in the memory 312 and executes image recognition processing to output the recognition result.

Such a configuration can save the volume of the data stored in the memory 312 and reduce the size of the apparatus configuration.

Furthermore, because the RAW data BF is not converted to the RGB data RGBF, loss of a texture is suppressed, and the recognition accuracy in the image recognition processing can be improved.

### <Image Recognition Processing by Image Recognition Apparatus of FIG. 13>

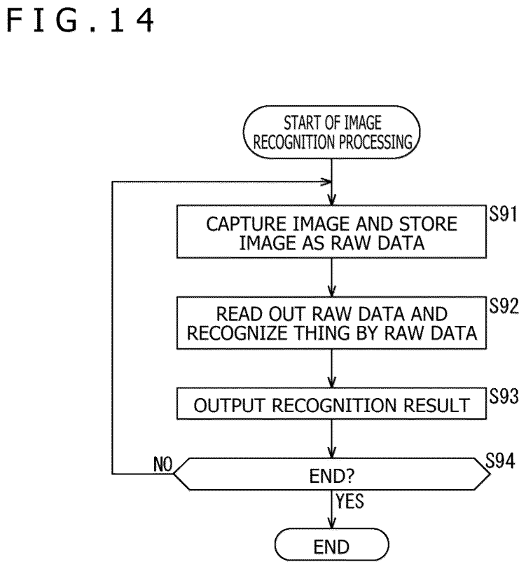

Next, with reference to a flowchart of FIG. 14, RAW data recognition processing by the image recognition apparatus 301 will be described.

In step S91, the imaging element 311 captures an image and outputs the image to the memory 312 as the imaging result including the RAW data BF to store it.

In step S92, the Bayer recognition section 313 reads out the RAW data BF from the memory 312 and executes recognition processing based on an image of the RAW data BF to recognize a thing.

In step S93, the Bayer recognition section 313 outputs the recognition result based on the image of the RAW data BF.

In step S94, whether or not an instruction to end the recognition processing has been made is determined. In the case in which an instruction to end the processing has not been made, the processing returns to step S91, and the subsequent processing is repeated.

That is, until an instruction to end the processing is made, the image recognition processing is repeated on the basis of the image of the RAW data BF from the image captured by the imaging element 311.

Then, when an instruction to end the processing is made in step S94, the recognition processing is ended.

The image recognition processing by the RAW data BF is implemented by the above processing. Therefore, the volume of the data stored in the memory 312 can be saved. In addition, because the RAW data BF is not converted to the RGB data RGBF, loss of a texture is suppressed, and the accuracy of recognition of a thing can be improved.

### 4. Modification Example of Learning Apparatus

In the above, description has been made about the example in which the RAW data BF that is the imaging result by the imaging element 311 is stored in the memory 312 as it is and is read out by the Bayer recognition section 313 to implement the image recognition processing. However, the Bayer recognition section 313 may be generated by retraining of an existing RGB recognition section by the RAW data BF.

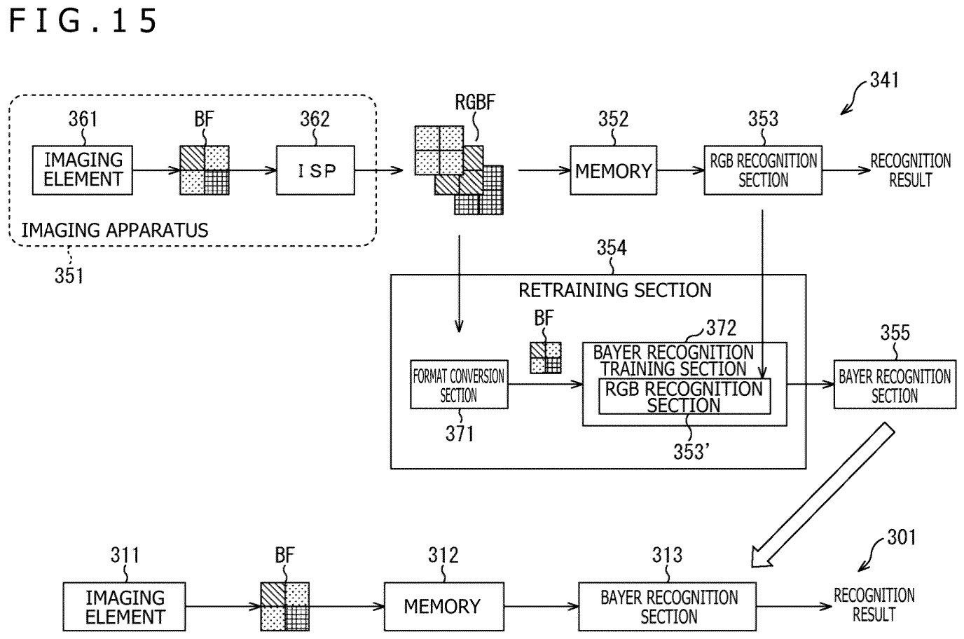

An upper stage of FIG. 15 illustrates a configuration example of a learning apparatus that allows a Bayer recognition section 355 (configuration corresponding to the Bayer recognition section 313) to be generated by retraining an existing RGB recognition section by the RAW data BF.

A learning apparatus 341 of FIG. 15 includes an imaging apparatus 351, a memory 352, an RGB recognition section 353, and a retraining section 354.

Note that the imaging apparatus 351, the memory 352, the RGB recognition section 353, an imaging element 361, and an ISP 362 in FIG. 15 are the same configurations corresponding to the imaging apparatus 31, the memory 32, the RGB recognition section 33, the imaging element 41, and the ISP 42 in the image recognition apparatus 11 of FIG. 1.

That is, a difference of the learning apparatus 341 of FIG. 15 from the image recognition apparatus 11 of FIG. 1 is that the retraining section 354 is disposed.

The retraining section 354 executes format conversion of the RGB data RGBF that is the imaging result by the imaging apparatus 351 to the RAW data BF, and retrains the trained RGB recognition section 353 (353′) by the RAW data BF to generate the Bayer recognition section 355. Note that the Bayer recognition section 355 is a configuration corresponding to the Bayer recognition section 313 in FIG. 13.

More specifically, the retraining section 354 includes a format conversion section 371 and a Bayer recognition training section 372.

The format conversion section 371 is the same configuration as the format conversion section 221 generated by the learning apparatus 201 of FIG. 6, and executes format conversion of the RGB data RGBF output as the imaging result by the imaging apparatus 351 to the RAW data BF and outputs the RAW data BF to the Bayer recognition training section 372 together with the RGB data RGBF.

By using the trained RGB recognition section 353′ capable of recognition processing using the same RGB data RGBF as the RGB recognition section 353, the Bayer recognition training section 372 trains the Bayer recognition section 355 capable of image recognition processing by the RAW data BF on the basis of the RAW data BF and the RGB data RGBF to output the Bayer recognition section 355.

That is, the RGB recognition section 353 is capable of image recognition processing based on the RGB data RGBF. Therefore, the Bayer recognition training section 372 generates the Bayer recognition section 355 by causing the RGB recognition section 353 to retrain an image recognition result with the corresponding RAW data BF regarding an image recognition result corresponding to the RGB data RGBF.

Then, as illustrated at a lower stage of FIG. 15, image recognition processing is implemented by applying the trained Bayer recognition section 355 as the Bayer recognition section 313 in the image recognition apparatus 301.

### <Training Processing by Learning Apparatus of FIG. 15>

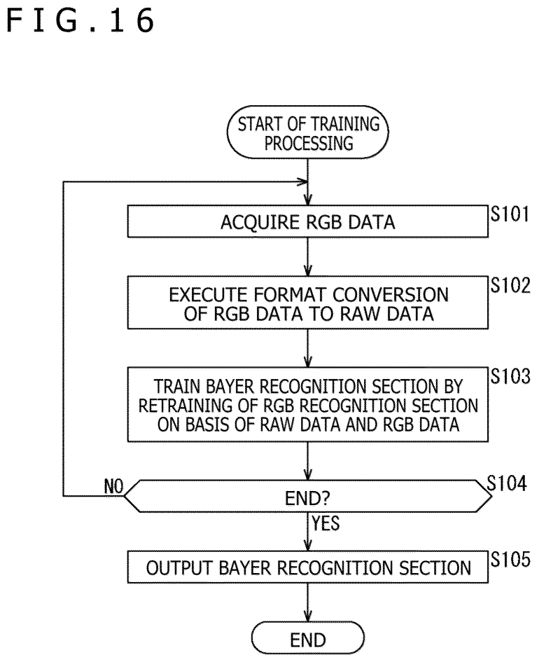

Next, with reference to a flowchart of FIG. 16, training processing by the learning apparatus 341 of FIG. 15 will be described.

In step S101, the format conversion section 371 of the retraining section 354 acquires the RGB data RGBF that is the imaging result by the imaging apparatus 351.

In step S102, the format conversion section 371 executes format conversion of the RGB data RGBF to the RAW data BF and outputs the RAW data BF to the Bayer recognition training section 372 together with the RGB data RGBF.

In step S103, the Bayer recognition training section 372 trains the Bayer recognition section 355 capable of image recognition processing by the RAW data BF by retraining the RGB recognition section 353′ on the basis of the RGB data RGBF and the RAW data BF.

In step S104, whether or not an instruction to end the training has been made is determined. In the case in which an instruction to end the training has not been made, the processing returns to step S101, and the subsequent processing is repeated.

That is, until an instruction to end the training is made, the processing of steps S101 to S104 is repeated, and the retraining by the retraining section 354 is repeated.

Then, when an instruction to end the training is made in step S104, the processing proceeds to step S105.

In step S105, the Bayer recognition training section 372 outputs the trained Bayer recognition section 355.

Through the above processing, the Bayer recognition section 355 capable of image recognition processing from the RAW data BF can be generated by retraining the RGB recognition section 353′ capable of image recognition processing from the RGB data RGBF.

### 5. Application Example of Image Recognition Apparatus

In the above, the example in which the image recognition processing by the Bayer recognition section 355 is implemented from the RAW data BF has been described. However, image recognition processing based on a format different from the RAW data BF may be implemented.

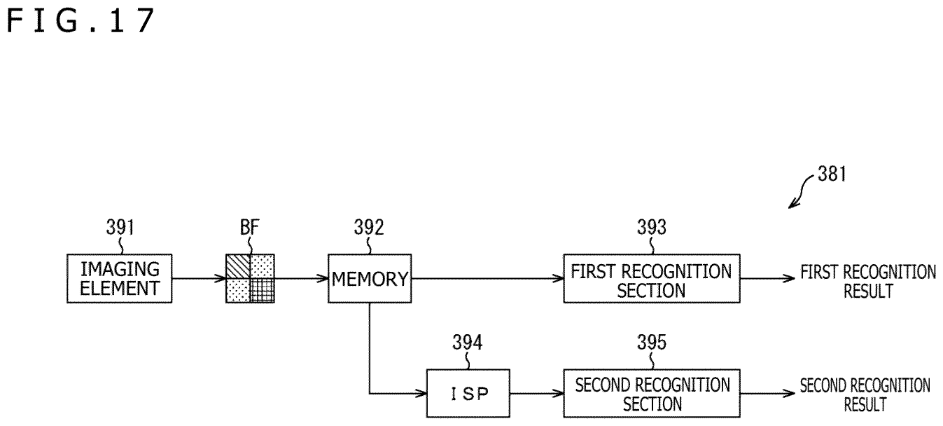

FIG. 17 illustrates a configuration example of an image recognition apparatus in which two different kinds of recognition processing are implemented from the RAW data BF.

An image recognition apparatus 381 of FIG. 17 includes an imaging element 391, a memory 392, a first recognition section 393, an ISP 394, and a second recognition section 395.

Note that the imaging element 391 and the memory 392 are the same functions as the imaging element 311 and the memory 312 in the image recognition apparatus 301, and therefore description thereof is omitted.

The first recognition section 393 is a recognizer such as an AI including a neural network that implements first recognition processing from the RAW data BF stored in the memory 392, and outputs the processing result by the first recognition processing as a first recognition result.

The ISP 394 executes predetermined signal processing for the RAW data BF stored in the memory 392 and outputs the predetermined signal processing result to the second recognition section 395. The ISP 394 is the ISP 282 of the imaging apparatus 271, for example. In this case, the ISP 394 converts the RAW data BF to the RGB data RGBF by demosaicing processing and outputs the RGB data RGBF to the second recognition section 395.

The second recognition section 395 is a recognizer such as an AI including a neural network that implements second recognition processing different from the first recognition processing implemented by the first recognition section 393 on the basis of the signal processing result supplied from the ISP 394, and outputs the processing result by the second recognition processing as a second recognition result.

For example, in the case in which the first recognition processing is image recognition processing based on the RAW data BF, the second recognition processing is recognition processing for a different format from the first recognition processing and is, for example, image recognition processing based on the RGB data RGBF.

Furthermore, the ISP 394 executes, for the RAW data BF, signal processing such as format conversion required for the second recognition processing and outputs the resulting data to the second recognition section 395.

The above processing can implement image recognition processing for multiple formats on the basis of the RAW data BF obtained by imaging by the imaging element 391. Moreover, image recognition processing for different use purposes can be simultaneously executed in the first recognition section 393 and the second recognition section 395 on the basis of the same RAW data.

Note that recognition processing of the image recognition apparatus of FIG. 17 is similar to that in the case in which image recognition processing is individually executed by each of the first recognition section 393 and the second recognition section 395, and therefore description thereof is omitted.

### 6. Application Example of Format Conversion Section

In the above, description has been made about the examples in which the RGB data RGBF is converted to the Bayer format as one example of RAW data by the format conversion section 221. However, the RGB data RGBF may be converted to RAW data of another format according to the type of data in each pixel of the imaging element 281 or the like.

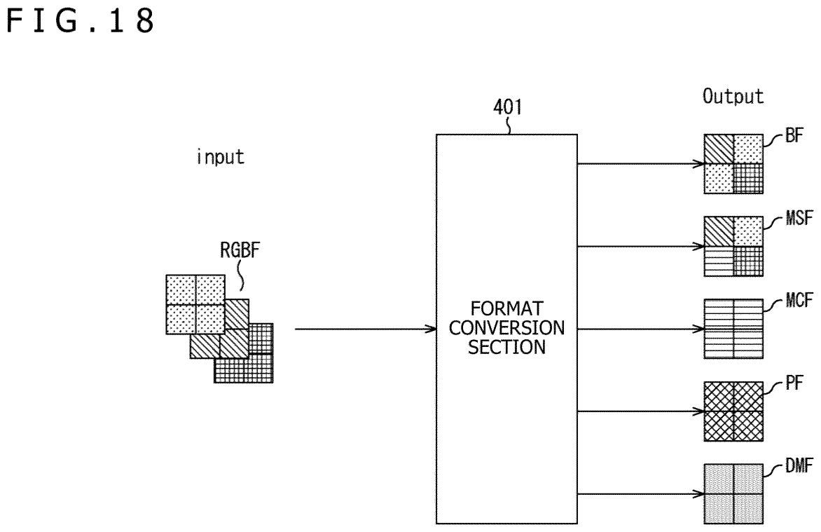

FIG. 18 illustrates an example of a format conversion section 401 including a neural network that converts the RGB data RGBF to RAW data of various formats.

Specifically, as illustrated in FIG. 18, the format conversion section 401 may be a configuration including a neural network that converts the RGB data RGBF to not only the RAW data BF of the Bayer format BF but also RAW data of formats like ones illustrated on second and subsequent rows in the diagram.

Specifically, the format conversion section 401 may convert the RGB data RGBF to RAW data of various formats such as a multi-spectrum format MSF including pixel values of more colors (bands) than three colors of RGB, a monochrome format MCF including pixel values of two colors of white and black, a polarization format PF including pixel values of multiple kinds of polarized light, or a depth map format DMF including pixel values (distance values) forming a depth map.

The RGB data RGBF can be converted to RAW data of various formats by such a format conversion section 401. Therefore, data for learning including the RAW data of various formats and a recognition result that serves as training data as a set can be generated.

Furthermore, because data for learning with various formats can be generated, image recognition processing can be implemented by RAW data itself that is the imaging result even with an imaging element that outputs RAW data of various formats as the imaging result. Therefore, the capacity of a memory at a subsequent stage of the imaging element can be saved. In addition, the influence attributed to loss of a texture that occurs due to conversion to the RGB data RGBF can be reduced.

### 7. Variations of RAW Data to which Conversion is Executed by Format Conversion Section

In the above, description has been made about the example in which, by the format conversion section 401, the RGB data RGBF is converted to RAW data of various formats such as the multi-spectrum format MSF, the monochrome format MCF, the polarization format PF, or the depth map format DMF. However, the RGB data RGBF may be converted to RAW data other than them.

In the following, description will be made about variations of RAW data to which conversion is executed from the RGB data RGBF by the format conversion section 401.

### 1: Example in Which 2×2 Pixels Form Pixel Block

As a variation of RAW data, as illustrated in FIG. 19, a format in which each group of R pixels, G pixels, and B pixels includes a pixel block made in units of 2×2 pixels (QBC (Quad Bayer coding) format) may be employed. In FIG. 19, a configuration in which an OCL (On Chip Lens: in the diagram, represented as “Lens”) illustrated by a circle mark is disposed regarding each of the respective pixels is made.

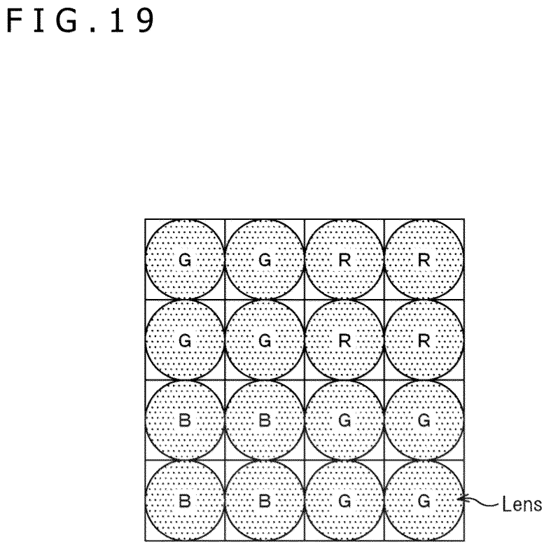

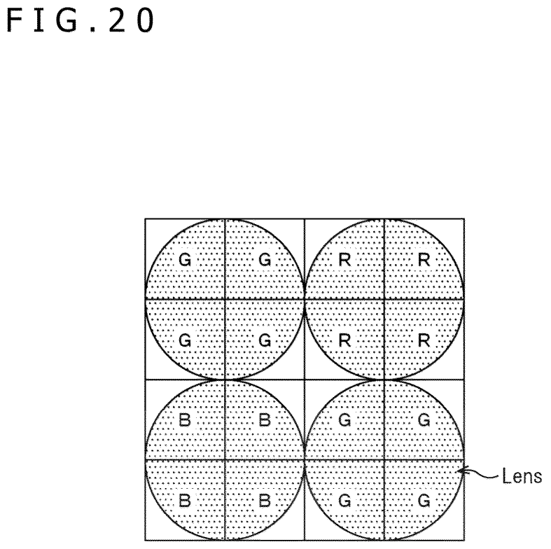

The OCLs may be formed in units of multiple pixels. For example, as illustrated in FIG. 20, the OCLs may be formed in units of a pixel block made in units of 2×2 pixels.

### 2: Example in Which 4×2 Pixels Form Pixel Block

In the above, description has been made about the format in which each group of R pixels, G pixels, and B pixels includes a pixel block made in units of 2×2 pixels. However, an OPDQBC format in which each group of R pixels, G pixels, and B pixels includes a pixel block made in units of 4×2 pixels may be employed.

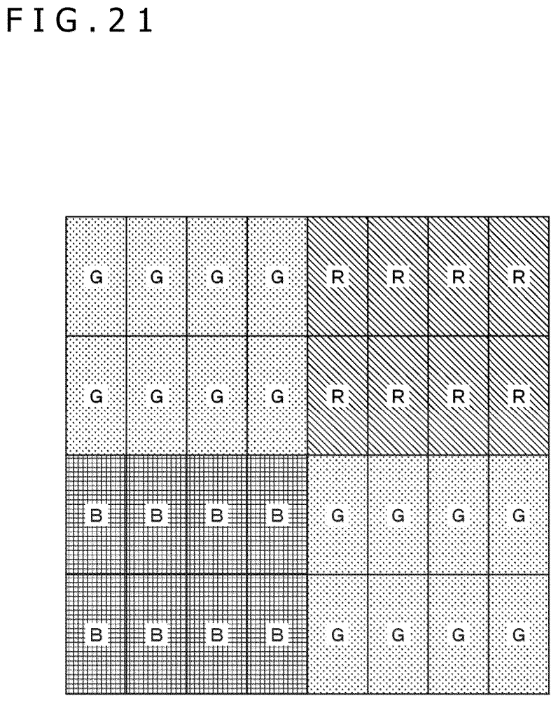

FIG. 21 illustrates a format in which each group of R pixels, G pixels, and B pixels includes a pixel block made in units of 4×2 pixels.

In the case of FIG. 21, for example, OCLs may be formed in pixel blocks made in units of 2×1 pixels or may be formed in units of a pixel block made in units of 4×2 pixels.

### 3: Example in which 3×3 Pixels Form Pixel Block

In the above, description has been made about the formats in which each group of R pixels, G pixels, and B pixels includes a pixel block made in units of 2×2 pixels or 4×2 pixels. However, the number of pixels forming the pixel block may be larger.

For example, a format in which each group of R pixels, G pixels, and B pixels includes a pixel block made in units of 3×3 pixels may be employed.

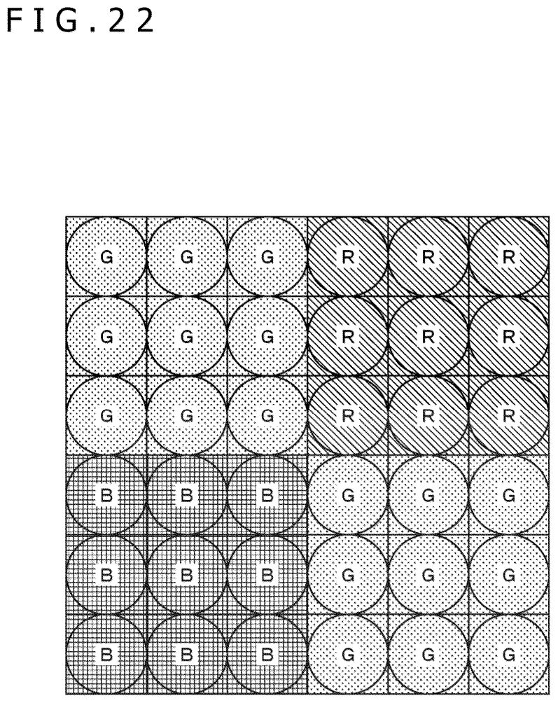

FIG. 22 illustrates a format in which each group of R pixels, G pixels, and B pixels includes a pixel block made in units of 3×3 pixels.

In the case of FIG. 22, an example in which, for example, OCLs are formed in units of each pixel similarly to the case of the QBC format of FIG. 19 is illustrated. However, for example, OCLs may be formed in units of a pixel block of 3×3 pixels.

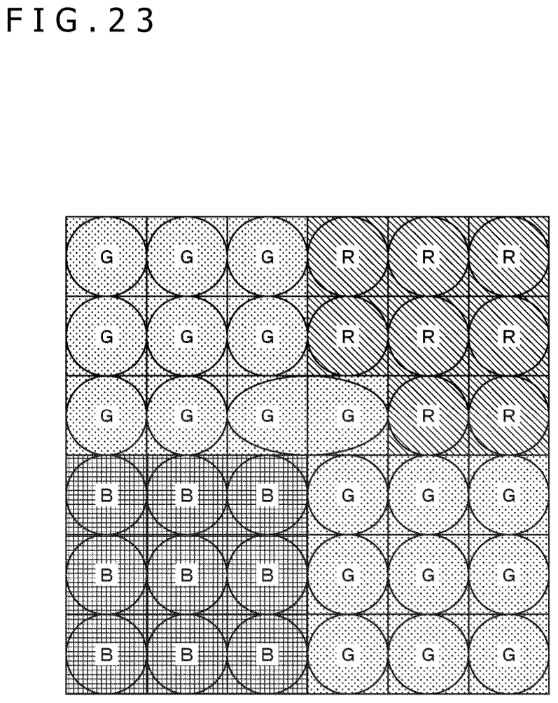

Moreover, phase difference detection pixels may be formed as illustrated in FIG. 23. In FIG. 23, the following format is made. An OCL with an elliptical shape is formed to straddle pixels on the third row from the top and on the second and third columns from the left, and these pixels are both G pixels.

Thus, 3×3 pixels+1 pixel on the upper left side are made into a pixel block including G pixels, and 3×3 pixels−1 pixel on the upper right side are made into a pixel block including R pixels. They are employed as pixel blocks for phase difference detection.

Furthermore, as illustrated in FIG. 24, pixel blocks for phase difference detection may be formed in such a manner that OCLs are formed to, as illustrated by a dotted line for each, straddle pixels on the first row from the top and on the second and third columns from the left and pixels on the second row from the top and on the second and third columns from the left.

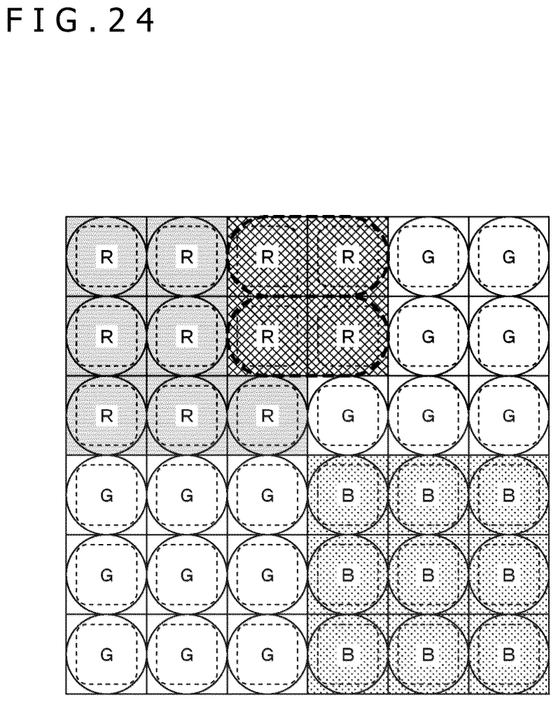

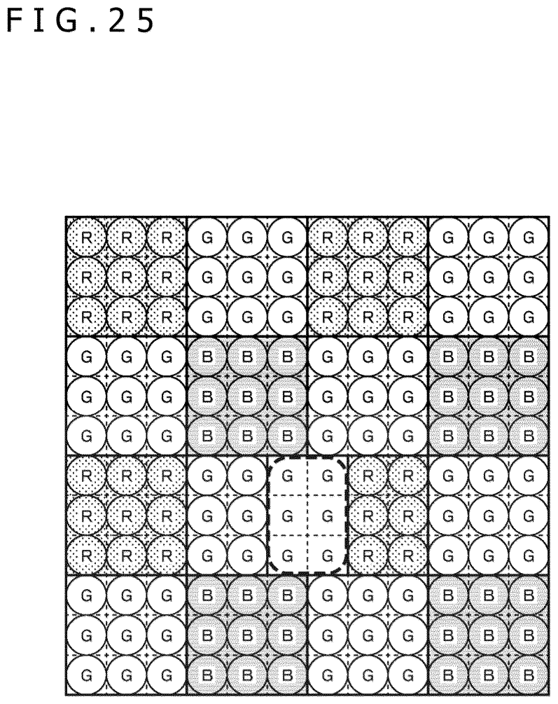

Moreover, as illustrated in FIG. 25, pixel blocks for phase difference detection may be formed in such a manner that an OCL is formed in a range of 2×3 pixels regarding the vertical direction×the horizontal direction surrounded by a dotted line.

### 4: Example in Which 4×4 Pixels Form Pixel Block

In the above, description has been made about the format in which each group of R pixels, G pixels, and B pixels includes a pixel block made in units of 3×3 pixels. However, a format in which each group includes a pixel block made in units of 4×4 pixels may be employed.

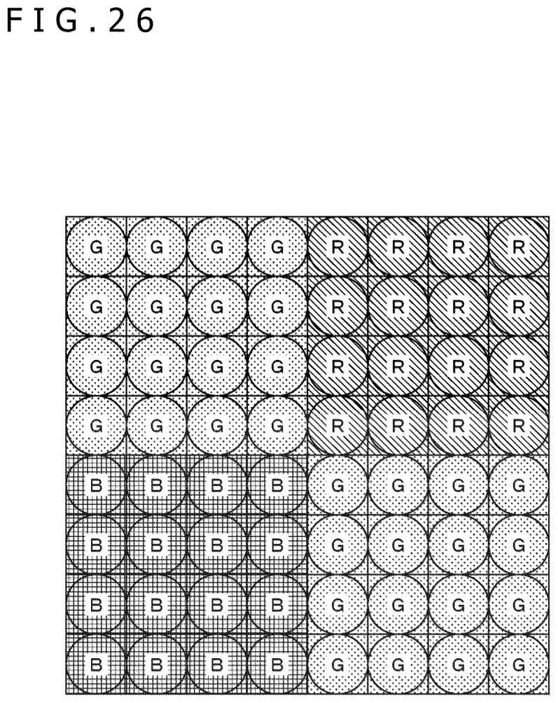

FIG. 26 illustrates a format in which each group of R pixels, G pixels, and B pixels includes a pixel block made in units of 4×4 pixels.

In the case of FIG. 26, for example, OCLs are formed in units of each pixel similarly to the case of the format of FIG. 19.

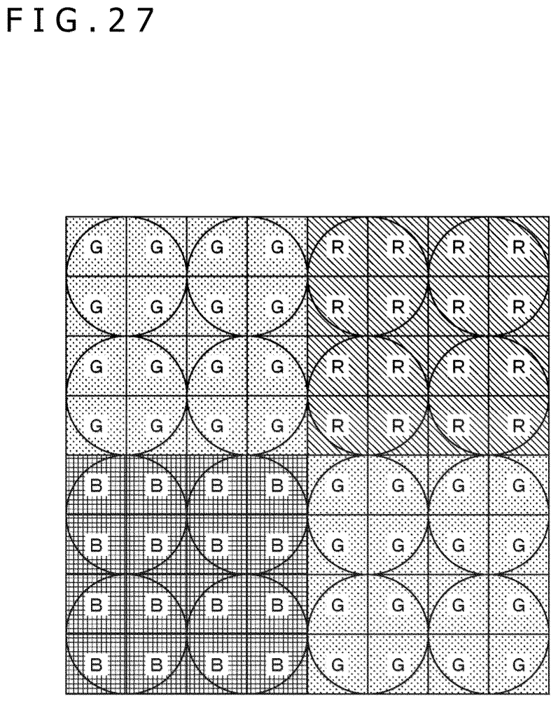

Furthermore, as illustrated in FIG. 27, for example, OCLs may be formed in pixel blocks made in units of 2×2 pixels.

Moreover, although not illustrated, OCLs may be formed in units of a pixel block made in units of 4×4 pixels.

Furthermore, the format including the pixel blocks made in units of 4×4 pixels illustrated in FIG. 27 can be made into formats suitable for various use purposes by switching binning in remosaicing executed in signal processing.

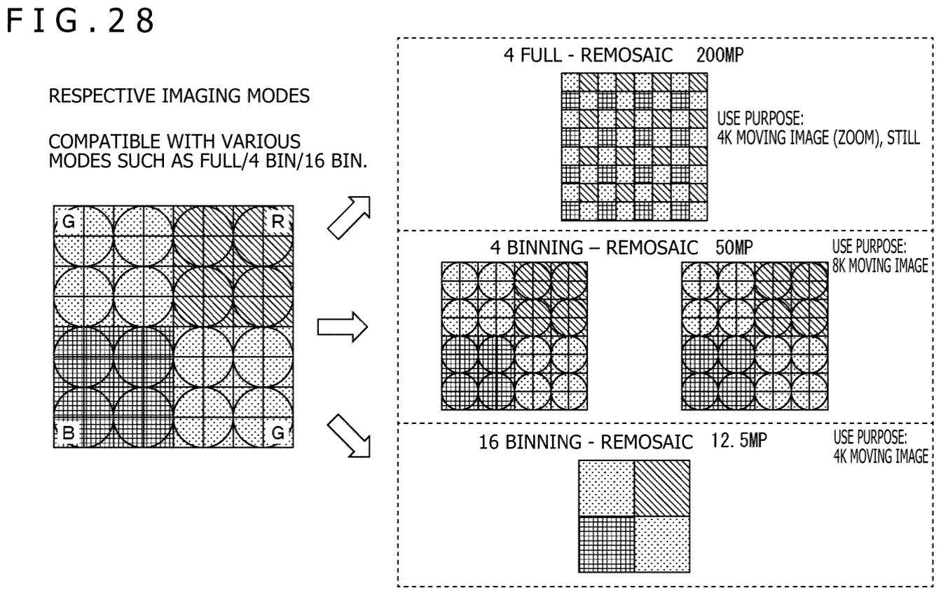

For example, as illustrated at an upper right stage in FIG. 28, for a 4K moving image (zoom) or a still image, for example, remosaicing (arrangement conversion processing) may be executed, with the respective pixels being an R pixel, a G pixel, and a B pixel, respectively.

Furthermore, for example, as illustrated at a middle right stage in FIG. 28, for an 8K moving image, for example, binning may be executed in units of 2×2 pixels, and remosaicing may be executed in such a manner that pixel blocks of R pixels, G pixels, and B pixels made in units of each are formed.

Moreover, for example, as illustrated at a lower right stage in FIG. 28, for a 4K moving image, for example, binning may be executed in units of 4×4 pixels, and remosaicing may be executed in such a manner that pixel blocks of R pixels, G pixels, and B pixels made in units of each are formed.

### 5: Example in which Pixels of Color Other than RGB Pixels are Used

In the above, the examples in which RGB pixels are used have been described. However, pixels of a color in a wavelength band other than them may be used.

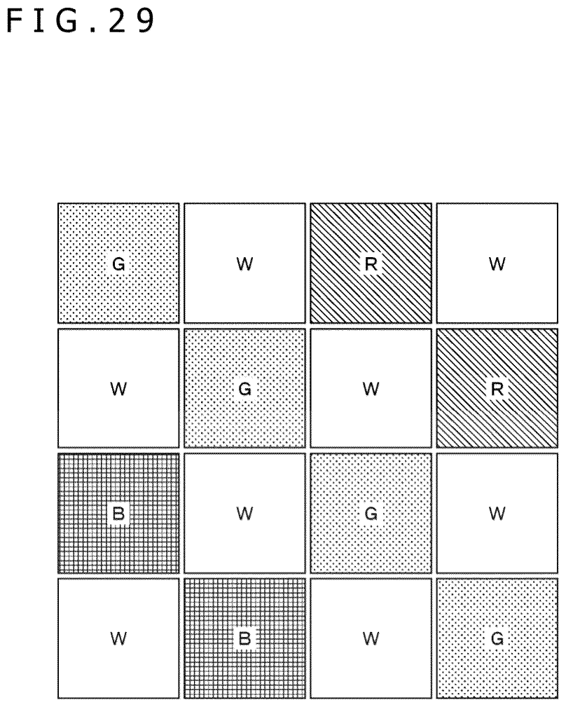

A format having a configuration illustrated in FIG. 29 may be employed. Specifically, in units of 2×2 pixels, an R pixel block including R pixels and W (white) pixels, G pixel blocks including G pixels and W pixels, and a B pixel block including B pixels and W pixels are formed. In addition, the RGB pixel blocks are disposed with the Bayer arrangement. In this case, the W pixels in the respective pixel blocks are disposed into a checkered pattern. The sensitivity is improved by the configuration in which the W pixels are used in this manner.

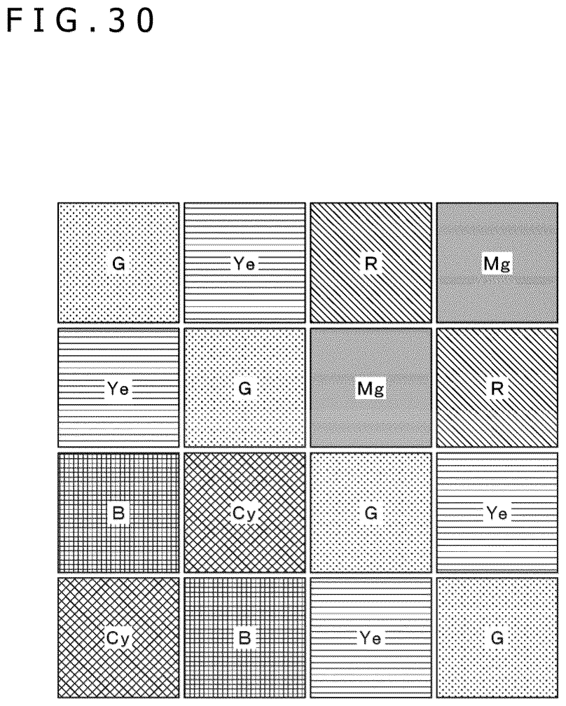

Furthermore, as illustrated in FIG. 30, pixels of complementary colors (Cyan, Magenta, Yellow) may be used instead of the W pixels in FIG. 29.

In FIG. 30, it is possible to employ a configuration in which G pixel blocks including G pixels and Ye (Yellow) pixels, an R pixel block including R pixels and M (Magenta) pixels, and a B pixel block including B pixels and Cy (Cyan) pixels are formed, and the RGB pixel blocks are disposed with the Bayer arrangement. In this case, the pixels of the complementary colors in the respective pixel blocks are disposed into a checkered pattern. The color reproducibility is improved by the configuration in which the pixels of the complementary colors are used in this manner.

In the above, description has been made about the examples in which the W pixels and the pixels of the complementary colors are disposed into a checkered pattern. However, they do not need to be disposed into a checkered pattern.

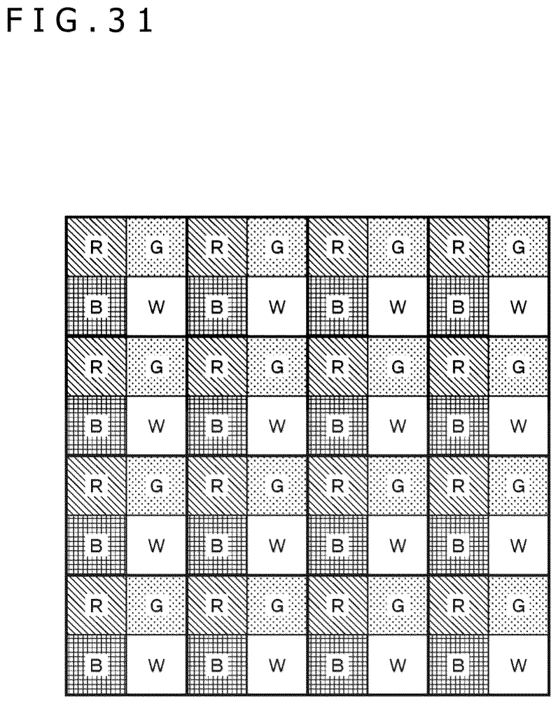

For example, as illustrated in FIG. 31, a format that employs 2×2 pixels as the unit and includes pixel blocks including RGB pixels and a white (white) pixel may be employed.

In the format of FIG. 31, IR (infrared light) pixels may be disposed instead of the W pixels.

Moreover, in the format of FIG. 31, Y (Yellow) pixels may be disposed instead of the W pixels.

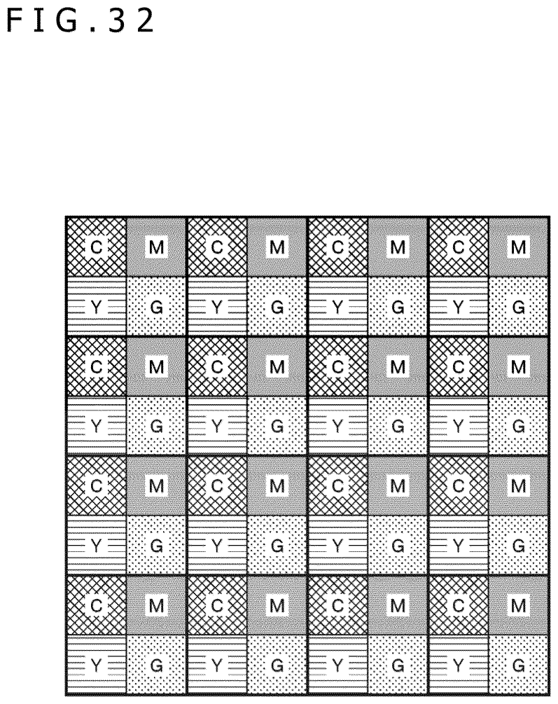

Furthermore, as illustrated in FIG. 32, a format that employs 2×2 pixels as the unit and includes pixel blocks including Y (Yellow) pixels, M (Magenta) pixels, C (Cyan) pixels, and G pixels may be employed.

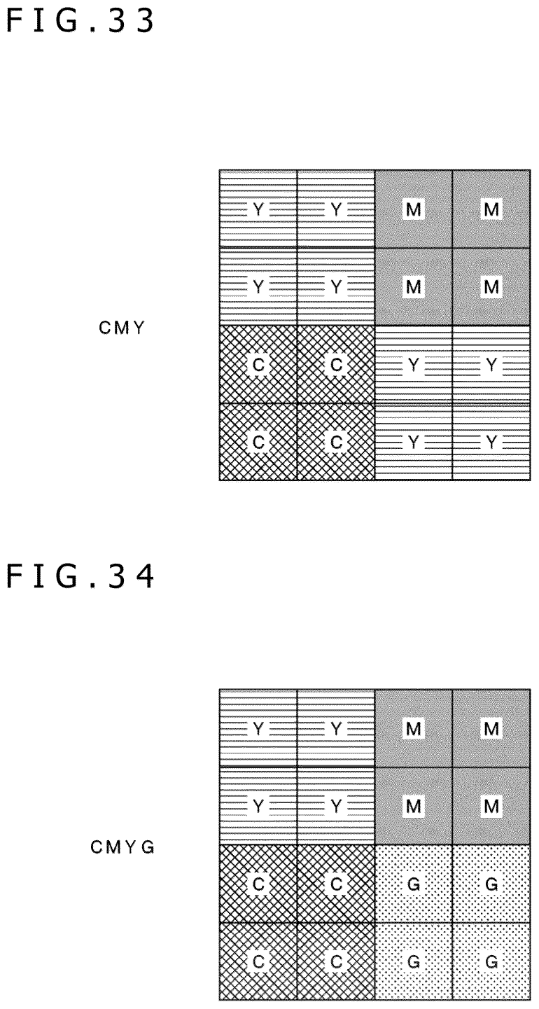

Moreover, as illustrated in FIG. 33, a format that employs 2×2 pixels as the unit and includes two pixel blocks including Y (Yellow) pixels, a pixel block including M (Magenta) pixels, and a pixel block including C (Cyan) pixels may be employed. In the case of FIG. 33, the two pixel blocks including Y (Yellow) pixels are disposed into a checkered pattern.

Furthermore, as illustrated in FIG. 34, a format that employs 2×2 pixels as the unit and includes a pixel block including Y (Yellow) pixels, a pixel block including M (Magenta) pixels, a pixel block including C (Cyan) pixels, and a pixel block including G pixels may be employed. In the case of FIG. 34, an arrangement in which either of the two pixel blocks including Y (Yellow) pixels in FIG. 33 is turned to the pixel block including G pixels is made.

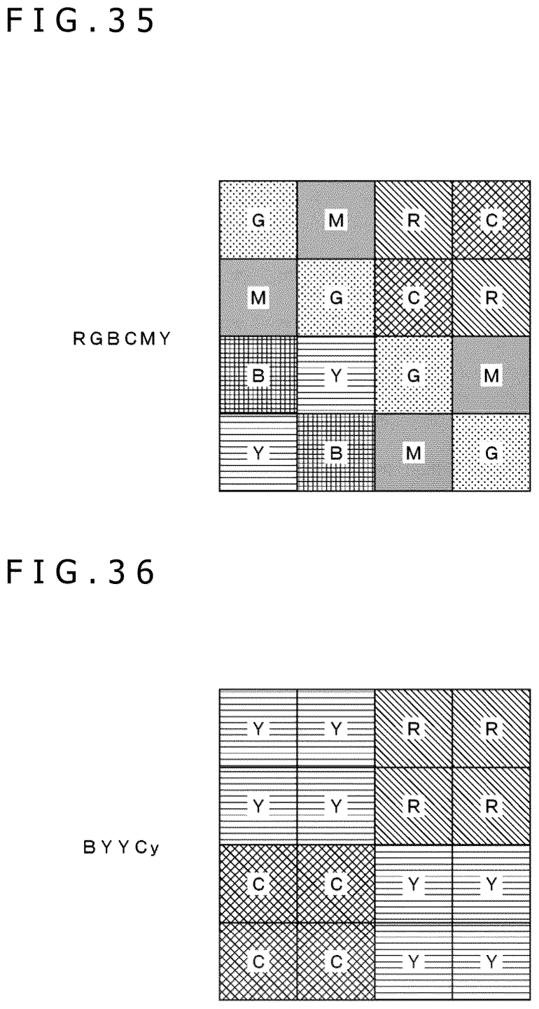

Moreover, as illustrated in FIG. 35, a format that employs 2×2 pixels as the unit and includes two pixel blocks including G pixels and M pixels, a pixel block including R pixels and C pixels, and a pixel block including B pixels and Y pixels may be employed.

In the case of FIG. 35, the two pixel blocks including G pixels and M pixels are employed as G pixel blocks. The pixel block including R pixels and C pixels is employed as an R pixel block, and a B pixel block including B pixels and Y pixels is employed. The Bayer arrangement with the RGB pixel blocks is made. In addition, the pixels of two colors forming each pixel block are each disposed into a checkered pattern.

Furthermore, as illustrated in FIG. 36, a format that employs 2×2 pixels as the unit and includes two pixel blocks including Y pixels, a pixel block including R pixels, and a pixel block including C pixels may be employed.

In the case of FIG. 36, the two pixel blocks including Y pixels are employed as G pixel blocks. The pixel block including R pixels is employed as an R pixel block, and a B pixel block including C pixels is employed. The Bayer arrangement with the RGB pixel blocks is made.

### 8. Example of Execution by Software

Incidentally, hardware can be caused to execute the above-described series of processing. It is also possible to cause software to execute the series of processing. In the case of causing software to execute the series of processing, a program that configures the software is installed from a recording medium into a computer embedded in dedicated hardware or, for example, a general-purpose computer or the like that can execute various functions by installation of various programs.

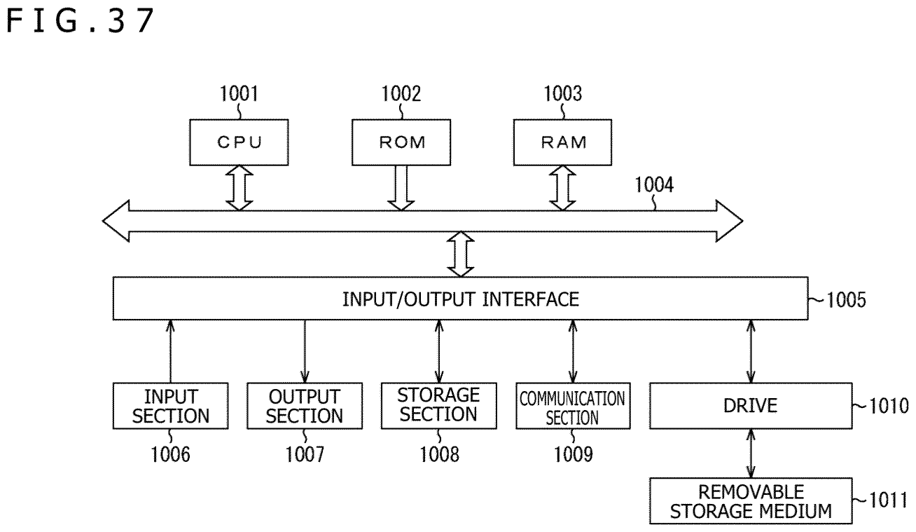

FIG. 37 illustrates a configuration example of a general-purpose computer. This computer incorporates a CPU (Central Processing Unit) 1001. An input-output interface 1005 is connected to the CPU 1001 through a bus 1004. A ROM (Read Only Memory) 1002 and a RAM (Random Access Memory) 1003 are connected to the bus 1004.

The following respective sections are connected to the input-output interface 1005: an input section 1006 including input devices such as a keyboard and a mouse to which an operation command is input by a user; an output section 1007 that outputs images of a processing operation screen and a processing result to a display device; a storage section 1008 including a hard disk drive and the like that store programs and various kinds of data; and a communication section 1009 that includes a LAN (Local Area Network) adapter and the like and executes communication processing through a network typified by the Internet. Furthermore, a drive 1010 that reads and writes data from and to a removable storage medium 1011 such as a magnetic disk (including flexible disk), an optical disc (including CD-ROM (Compact Disc-Read Only Memory) and DVD (Digital Versatile Disc)), a magneto-optical disk (including MD (Mini Disc), or a semiconductor memory is connected.

The CPU 1001 executes various kinds of processing in accordance with a program stored in the ROM 1002 or a program that has been read out from the removable storage medium 1011 such as a magnetic disk, an optical disc, a magneto-optical disk, or a semiconductor memory and has been installed in the storage section 1008 to be loaded from the storage section 1008 into the RAM 1003. Data and the like necessary for execution of various kinds of processing by the CPU 1001 are also stored in the RAM 1003 as appropriate.

In the computer configured as above, the CPU 1001 loads, for example, a program stored in the storage section 1008 into the RAM 1003 through the input-output interface 1005 and the bus 1004 and executes the program. Thereby, the above-described series of processing is executed.

For example, the program to be executed by the computer (CPU 1001) can be recorded in the removable storage medium 1011 such as a package medium and can be provided. Furthermore, the program can be provided through a wired or wireless transmission medium such as a local area network, the Internet, or digital satellite broadcasting.

In the computer, the program can be installed in the storage section 1008 through the input-output interface 1005 by mounting the removable storage medium 1011 in the drive 1010. Moreover, the program can be received by the communication section 1009 through a wired or wireless transmission medium and can be installed in the storage section 1008. Besides, the program can be installed in the ROM 1002 or the storage section 1008 in advance.

Note that the program executed by the computer may be a program regarding which processing is executed in a time-series manner along the order of explanation in the present specification or a program regarding which processing is executed at a necessary timing such as the timing when invocation is executed.

Note that the CPU 1001 in FIG. 37 implements functions of the learning apparatus 201 of FIG. 6, the learning apparatus 251 of FIG. 8, the image recognition apparatus 261 of FIG. 9, the image recognition apparatus 301 of FIG. 13, the learning apparatus 341 of FIG. 15, the image recognition apparatus 381 of FIG. 17, and the format conversion section 401 of FIG. 18.

Furthermore, in the present specification, a system means a collection of multiple constituent elements (apparatuses, modules (parts), and the like) and is irrespective of whether or not all constituent elements exist in the same casing. Therefore, multiple apparatuses that are housed in different casings and are connected through a network and one apparatus in which multiple modules are housed in one casing are both systems.

Note that an embodiment of the present disclosure is not limited to the above-described embodiment and various changes are possible within such a range as not to depart from the gist of the present disclosure.

For example, the present disclosure can adopt a configuration of cloud computing in which one function is processed by multiple apparatuses in a sharing and cooperative manner through a network.

Furthermore, the respective steps described in the above-described flowcharts can be executed by multiple apparatuses in a sharing manner besides being executed by one apparatus.

Moreover, in the case in which multiple kinds of processing are included in one step, the multiple kinds of processing included in the one step can be executed by multiple apparatuses in a sharing manner besides being executed by one apparatus.

Note that the present disclosure can also adopt the following configurations.

<1>

An image processing apparatus including:
a format conversion section that converts RGB data to RAW data.
   <2>

The image processing apparatus according to <1>, in which
the format conversion section is generated by adversarial training with a determination section that determines authenticity of the RAW data arising from conversion from the RGB data with respect to RAW data before being converted to the RGB data.
   <3>

The image processing apparatus according to <1> or <2>, in which the format conversion section downscales the RAW data arising from conversion after converting the RGB data to the RAW data.

<4>

The image processing apparatus according to any one of <1> to <3>, in which the format conversion section converts learning data including the RGB data and a training recognition result to the learning data including the RAW data and the training recognition result.

<5>

The image processing apparatus according to <4>, further including:
a RAW data recognition section that is generated by learning using the learning data including the RAW data and the training recognition result and executes image recognition processing for an image of the RAW data.
   <6>

The image processing apparatus according to <5>, further including:
an imaging apparatus that captures the image and outputs the image as the RGB data, in which
the format conversion section converts the RGB data output from the imaging apparatus, to the RAW data, and
the RAW data recognition section executes the image recognition processing on the basis of the RAW data for which format conversion has been executed by the format conversion section.
   <7>

The image processing apparatus according to <6>, in which
the imaging apparatus includes
   an imaging element that captures the image and outputs the image as the RAW data, and
   a signal processing section that executes demosaicing processing for the RAW data output from the imaging element, to convert the RAW data to the RGB data and output the RGB data.
      <8>

The image processing apparatus according to <5>, further including:
an imaging element that captures the image and outputs the image as the RAW data, in which
the RAW data recognition section executes the image recognition processing on the basis of the RAW data output from the imaging element.
   <9>

The image processing apparatus according to any one of <1> to <3>, further including:
a RAW data recognition section that is generated by retraining a trained RGB recognition section that executes image recognition processing for an image of the RGB data by using the RAW data for which format conversion from the RGB data has been executed by the format conversion section, and executes image recognition processing for an image of the RAW data.
   <10>

The image processing apparatus according to any one of <1> to <9>, in which
the RAW data includes a Bayer format, a multi-spectrum format, a monochrome format, a polarization format, or a depth map format.
   <11>

An information processing method including a step of:
converting RGB data to RAW data.
   <12>

A program that causes a computer to function as:
a format conversion section that converts RGB data to RAW data.
   <13>

An image processing apparatus including:
a RAW data recognition section that executes image recognition processing on the basis of an image of RAW data.
   <14>

The image processing apparatus according to <13>, in which
the RAW data recognition section is generated by learning based on learning data including the RAW data and a training recognition result, and
the learning data including the RAW data and the training recognition result includes learning data arising from format conversion from learning data including RGB data and the training recognition result.
   <15>

The image processing apparatus according to <13>, in which
the RAW data recognition section arises from retraining a trained RGB recognition section that executes image recognition processing for an image of RGB data by using the RAW data generated by format conversion from the RGB data.
   <16>

The image processing apparatus according to <13>, further including:
a signal processing section that executes predetermined signal processing for the RAW data to convert the RAW data to another format; and
another data recognition section that executes image recognition processing for an image of the other format to which conversion has been executed by the signal processing section.
   <17>

An information processing method including a step of:
executing image recognition processing on the basis of an image of RAW data.
   <18>

A program that causes a computer to function as:
a RAW data recognition section that executes image recognition processing on the basis of an image of RAW data.
   <19>

An image processing apparatus including:
an image recognition section to which image data corresponding to an image of a first arrangement according to an arrangement of a pixel array including an imaging element is input, the image recognition section executing image recognition processing for the image data and outputting a recognition processing result, in which
the image recognition section is trained by using the image data corresponding to the image of the first arrangement generated by converting an image of a second arrangement different from the first arrangement.
   <20>

An image processing method of an image processing apparatus including an image recognition section to which image data corresponding to an image of a first arrangement according to an arrangement of a pixel array including an imaging element is input, the image recognition section executing image recognition processing for the image data and outputting a recognition processing result, the image processing method including a step of:

by the image recognition section, executing the image recognition processing for the image data and outputting the recognition processing result after execution of learning of the image recognition processing using the image data corresponding to the image of the first arrangement generated by conversion of an image of a second arrangement different from the first arrangement.

<21>

An image conversion apparatus including:
an image conversion section that converts an RGB image having an R image, a G image, and a B image to an image including another arrangement different from an arrangement of the RGB image output according to an arrangement of a pixel array including an imaging element, in which
the image including the other arrangement is used for learning of an image recognition section used for image inference processing based on the image including the other arrangement.
   <22>

An image conversion method including a step of:
converting an RGB image having an R image, a G image, and a B image to an image including another arrangement different from an arrangement of the RGB image output according to an arrangement of a pixel array including an imaging element, in which
the image including the other arrangement is used for learning of an image recognition section used for image inference processing based on the image including the other arrangement.
   <23>

An AI network generation apparatus including:
an image conversion section that converts an input image of a first arrangement to an image of a second arrangement different from the first arrangement and outputs the image of the second arrangement; and
an AI network training section that generates a trained AI network by training an AI network by using the image of the second arrangement output from the image conversion section.
   <24>

An AI network generation method including steps of:
converting an input image of a first arrangement to an image of a second arrangement different from the first arrangement and outputting the image of the second arrangement; and
generating a trained AI network by training an AI network by using the output image of the second arrangement.

### REFERENCE SIGNS LIST

201: Learning apparatus
211: Imaging element
212: ISP
213: Format conversion training section
214: Determination training section
221: Format conversion section
231: Determination section
241: Format conversion section
242: Bayer recognition training section
243: Bayer recognition section
251: Learning apparatus
261: Image recognition apparatus
271: Imaging apparatus
272: Format conversion section
273: Memory
274: Bayer recognition section
281: Imaging element
282: ISP
301: Image recognition apparatus
311: Imaging element
312: Memory
313: Bayer recognition section
341: Learning apparatus
351: Imaging apparatus
352: Memory
353, 353′: RGB recognition section
354: Retraining section
355: Bayer recognition section
361: Imaging element
362: ISP
371: Format conversion section
372: Bayer recognition training section
381: Image recognition apparatus
391: Imaging element
392: Memory
393: First recognition section
394: ISP
395: Second recognition section
401: Format conversion section

1. An image processing apparatus comprising:
a format conversion section that converts RGB data to RAW data.

2. The image processing apparatus according to claim 1, wherein
the format conversion section is generated by adversarial training with a determination section that determines authenticity of the RAW data arising from conversion from the RGB data with respect to RAW data before being converted to the RGB data.

3. The image processing apparatus according to claim 1, wherein
the format conversion section downscales the RAW data arising from conversion after converting the RGB data to the RAW data.

4. The image processing apparatus according to claim 1, wherein
the format conversion section converts learning data including the RGB data and a training recognition result to the learning data including the RAW data and the training recognition result.

5. The image processing apparatus according to claim 4, further comprising:
a RAW data recognition section that is generated by learning using the learning data including the RAW data and the training recognition result and executes image recognition processing for an image of the RAW data.

6. The image processing apparatus according to claim 5, further comprising:
an imaging apparatus that captures the image and outputs the image as the RGB data, wherein
the format conversion section converts the RGB data output from the imaging apparatus, to the RAW data, and
the RAW data recognition section executes the image recognition processing on a basis of the RAW data for which format conversion has been executed by the format conversion section.

7. The image processing apparatus according to claim 6, wherein
the imaging apparatus includes
an imaging element that captures the image and outputs the image as the RAW data, and
a signal processing section that executes demosaicing processing for the RAW data output from the imaging element, to convert the RAW data to the RGB data and output the RGB data.

8. The image processing apparatus according to claim 5, further comprising:
an imaging element that captures the image and outputs the image as the RAW data, wherein
the RAW data recognition section executes the image recognition processing on a basis of the RAW data output from the imaging element.

9. The image processing apparatus according to claim 1, further comprising:
a RAW data recognition section that is generated by retraining a trained RGB recognition section that executes image recognition processing for an image of the RGB data by using the RAW data for which format conversion from the RGB data has been executed by the format conversion section, and executes image recognition processing for an image of the RAW data.

10. The image processing apparatus according to claim 1, wherein
the RAW data includes a Bayer format, a multi-spectrum format, a monochrome format, a polarization format, or a depth map format.

11. An information processing method comprising a step of:
converting RGB data to RAW data.

12. A program that causes a computer to function as:
a format conversion section that converts RGB data to RAW data.

13. An image processing apparatus comprising:
a RAW data recognition section that executes image recognition processing on a basis of an image of RAW data.

14. The image processing apparatus according to claim 13, wherein
the RAW data recognition section is generated by learning based on learning data including the RAW data and a training recognition result, and
the learning data including the RAW data and the training recognition result includes learning data arising from format conversion from learning data including RGB data and the training recognition result.

15. The image processing apparatus according to claim 13, wherein
the RAW data recognition section arises from retraining a trained RGB recognition section that executes image recognition processing for an image of RGB data by using the RAW data generated by format conversion from the RGB data.

16. The image processing apparatus according to claim 13, further comprising:
a signal processing section that executes predetermined signal processing for the RAW data to convert the RAW data to another format; and
another data recognition section that executes image recognition processing for an image of the other format to which conversion has been executed by the signal processing section.

17. An information processing method comprising a step of:
executing image recognition processing on a basis of an image of RAW data.

18. A program that causes a computer to function as:
a RAW data recognition section that executes image recognition processing on a basis of an image of RAW data.

19. An image processing apparatus comprising:
an image recognition section to which image data corresponding to an image of a first arrangement according to an arrangement of a pixel array including an imaging element is input, the image recognition section executing image recognition processing for the image data and outputting a recognition processing result, wherein
the image recognition section is trained by using the image data corresponding to the image of the first arrangement generated by converting an image of a second arrangement different from the first arrangement.

20. An image processing method of an image processing apparatus including an image recognition section to which image data corresponding to an image of a first arrangement according to an arrangement of a pixel array including an imaging element is input, the image recognition section executing image recognition processing for the image data and outputting a recognition processing result, the image processing method comprising a step of:
by the image recognition section, executing the image recognition processing for the image data and outputting the recognition processing result after execution of learning of the image recognition processing using the image data corresponding to the image of the first arrangement generated by conversion of an image of a second arrangement different from the first arrangement.

21. An image conversion apparatus comprising:
an image conversion section that converts an RGB image having an R image, a G image, and a B image to an image including another arrangement different from an arrangement of the RGB image output according to an arrangement of a pixel array including an imaging element, wherein
the image including the other arrangement is used for learning of an image recognition section used for image inference processing based on the image including the other arrangement.

22. An image conversion method comprising a step of:
converting an RGB image having an R image, a G image, and a B image to an image including another arrangement different from an arrangement of the RGB image output according to an arrangement of a pixel array including an imaging element, wherein
the image including the other arrangement is used for learning of an image recognition section used for image inference processing based on the image including the other arrangement.

23. An AI network generation apparatus comprising:
an image conversion section that converts an input image of a first arrangement to an image of a second arrangement different from the first arrangement and outputs the image of the second arrangement; and
an AI network training section that generates a trained AI network by training an AI network by using the image of the second arrangement output from the image conversion section.

24. An AI network generation method comprising steps of:
converting an input image of a first arrangement to an image of a second arrangement different from the first arrangement and outputting the image of the second arrangement; and
generating a trained AI network by training an AI network by using the output image of the second arrangement.
